(19) United States
(12) Patent Application Publication
(10) Pub. No.: US 2024/0296594 A1
(43) Pub. Date: Sep. 5, 2024

(54) Generalized Difference Coder for Residual Coding in Video Compression

(71) Applicants: HUAWEI TECHNOLOGIES CO., LTD., Shenzhen (CN); FRIEDRICH-ALEXANDER-UNIVERSITAT, ERLANGEN-NURNBERG, Erlangen (DE)

(72) Inventors: Timofey Mikhailovich Solovyev, Munich (DE); Fabian Brand, Erlangen (DE); Jürgen Seiler, Erlangen (DE); Andre Kaup, Erlangen (DE); Elena Alexandrovna Alshina, Munich (DE)

(21) Appl. No.: 18/662,752

(22) Filed: May 13, 2024

Related U.S. Application Data
(63) Continuation of application No. PCT/RU2021/000506, filed on Nov. 16, 2021.

(51) Int. Cl. G06T 9/00; H04N 19/20; H04N 19/587

(52) U.S. Cl. CPC G06T 9/002; H04N 19/20; H04N 19/587

(57) ABSTRACT

This application provides methods and apparatuses for encoding image or video related data into a bitstream. The present disclosure may be applied in the field of artificial intelligence (AI)-based video or picture compression technologies, and in particular, to the field of neural network-based video compression technologies. A neural network (generalized difference) is applied to a signal and a predicted signal during the encoding to obtain a generalized residual. During the decoding another neural network (generalized sum) may be applied to a reconstructed generalized residual and the predicted signal to obtain a reconstructed signal.

### CROSS-REFERENCE TO RELATED APPLICATIONS

This application is a continuation of International Application No. PCT/RU2021/000506, filed on Nov. 16, 2021, the disclosure of which is hereby incorporated by reference in its entirety.

The present disclosure relates to encoding a signal into a bitstream and decoding a signal from a bitstream. In particular, the present disclosure relates to obtaining residuals by applying a neural network in the encoding and reconstructing the signal by applying a neural network in the decoding.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, mobile device video recording, and camcorders of security applications.

Since the development of the block-based hybrid video coding approach in the H.261 standard in 1990, new video coding techniques and tools were developed and formed the basis for new video coding standards. One of the goals of most of the video coding standards was to achieve a bitrate reduction compared to its predecessor without sacrificing picture quality. Further video coding standards comprise MPEG-1 video, MPEG-2 video, VP8, VP9, AV1, ITU-T H.262/MPEG-2, ITU-T H.263, ITU-T H.264/MPEG-4, Part 10, Advanced Video Coding (AVC), ITU-T H.265, High Efficiency Video Coding (HEVC), ITU-T H.266, Versatile Video Coding (VVC) and extensions, such as scalability and/or three-dimensional (3D) extensions, of these standards.

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in picture quality are desirable.

The encoding and decoding of the video may be performed by standard video encoders and decoders, compatible with H.264/AVC, HEVC (H.265), VVC (H.266) or other video coding technologies, for example. Moreover, the video coding or its parts may be performed by neural networks.

In recent years, deep learning is gaining popularity in the fields of picture and video encoding and decoding.

### SUMMARY

The embodiments of the present disclosure provide apparatuses and methods for obtaining residuals by applying a neural network in the encoding and reconstructing the signal by applying a neural network in the decoding.

The embodiments of the invention are defined by the features of the independent claims, and further advantageous implementations of the embodiments by the features of the dependent claims.

According to an embodiment a method is provided for decoding a signal from a bitstream, comprising: decoding from the bitstream a set of features and a residual signal; obtaining a prediction signal; outputting the signal including determining whether to output a first reconstructed signal or a second reconstructed signal, or combining the first reconstructed signal and the second reconstructed signal; wherein the first reconstructed signal is based on the residual signal and the prediction signal; and the second reconstructed signal is obtained by processing the set of features and the prediction signal by applying one or more layers of a first neural network.

The method considers a generalized residual signal, i.e. a set of features, in combination with a prediction signal to reconstruct (decode) a signal from the bitstream. The generalized residual and the prediction signal are processed by layers of a neural network. Such operation may be referred to as “generalized sum”, as the method may reconstruct the signal by combining the generalized residual and the prediction signal. Such a non-linear, non-local operation may utilize additional redundancies in the signal and the prediction signal. Thus, the size of the bitstream may be reduced.

In an exemplary implementation, the combining further comprises processing the first reconstructed signal and the second reconstructed signal by applying a second neural network.

Combining the first reconstructed signal and the second reconstructed signal by applying a neural network may improve the quality of the output signal by exploiting additional hidden features.

For example, the second neural network is applied on frame level, or on block level, or on predetermined shapes obtained by applying a mask indicating at least one area within a subframe, or on predetermined shapes obtained by applying a pixel-wise soft mask.

Applying the second neural network on smaller areas than a frame may lead to an improved quality of the output signal, whereas applying the second neural network on frame level may reduce processing amount. An even more refined output signal may be obtained by using predetermined shapes for the smaller areas.

In an exemplary implementation, the determination is performed on frame level, or on block level, or on predetermined shapes obtained by applying a mask indicating at least one area within a subframe, or on predetermined shapes obtained by applying a pixel-wise soft mask.

Performing the determination on smaller areas than a frame may lead to an improved quality of the output signal, whereas performing the determination on frame level may reduce processing amount. An even more refined output signal may be obtained by using predetermined shapes for the smaller areas.

For example, in the obtaining of the second reconstructed signal, the prediction signal is added to an output of the first neural network.

Adding the prediction signal to the output of the first neural network may lead to an improved performance, as the first neural network is trained for filtering in such exemplary implementation.

In an exemplary implementation, at least one of the first neural network or the second neural network is a convolutional neural network.

A convolutional neural network may provide an efficient implementation of a neural network.

For example, the decoding is performed by a decoder of an autoencoder.

The coding may be readily and advantageously applied to effectively reduce the data rate, e.g. when transmission or storage of pictures or videos is desired. The processing by an autoencoder to encode/decode a signal may detect additional redundancies in the data to be encoded.

In an exemplary implementation, a training of the first neural network and the autoencoder is performed in an end-to-end manner.

A training of the network performing the generalized sum and the autoencoder may lead to an improved encoding/decoding performance.

For example, the decoding is performed by a hybrid block-based decoder.

A generalized residual may be readily and advantageously applied in combination with a hybrid block-based encoder and decoder may improve the coding rate.

In an exemplary implementation, the decoding includes applying one or more of a hyperprior, an autoregressive model, and a factorized entropy model.

Introducing a hyper-prior and/or an autoregressive model, and/or a factorized entropy model may further improve the probability model and thus the coding rate by determining further redundancy in the data to be encoded.

For example, the signal to be decoded is a current frame.

A current frame of image or video data may be encoded and decoded efficiently by utilizing a generalized residual.

In an exemplary implementation, the prediction signal is obtained from at least one previous frame and at least one motion field.

Obtaining the prediction signal by utilizing at least one previous frame and at least one motion field may lead to a more refined prediction signal, thus improving the performance of encoding/decoding.

For example, the signal to be decoded is a current motion field.

A current motion field related to image or video data may be encoded and decoded efficiently by utilizing a generalized residual.

In an exemplary implementation, the prediction signal is obtained from at least one previous motion field.

Obtaining the prediction signal by utilizing at least one previous motion field may lead to a more refined prediction signal, thus improving the performance of encoding/decoding.

For example, the residual signal represents an area, and the decoding from the bitstream a residual signal further comprises: decoding a first flag from the bitstream, setting samples of the residual signal within a first area included in said area equal to a default sample value if the first flag is equal to a predefined value.

Setting samples within an area to a default value as indicated by a flag may remove noise due to the decoding from said samples.

In an exemplary implementation, the first area has rectangular shape.

A rectangular shape may provide an efficient implementation for such an area.

For example, the default sample value is equal to zero.

Removing noise from samples within an area may improve subsequent processing, especially for small sample values close to zero.

In an exemplary implementation, the set of features represents an area, and the decoding from the bitstream a set of features further comprises: decoding a second flag from the bitstream, setting values of the features within a second area included in said area equal to a default feature value if the second flag is equal to a predefined value.

Setting values of features within an area to a default value as indicated by a flag may remove noise due to the decoding from said features.

For example, the second area has rectangular shape.

A rectangular shape may provide an efficient implementation for such an area.

In an exemplary implementation, the default feature value is equal to zero.

Removing noise from values of features within an area may improve subsequent processing, especially for small values close to zero.

For example, the residual signal represents an area, the set of features represents the area, and the decoding from the bitstream a set of features and a residual signal further comprises: decoding a third flag from the bitstream, setting samples of the residual signal within a third area included in said area equal to a default sample value and values of the features within a fourth area included in said area equal to a default feature value if the third flag is equal to a predefined value.

Setting samples within a third area and values of features within a fourth area to a respective default value as indicated by a flag may remove noise due to the decoding from said samples and said features.

In an exemplary implementation, at least one of the third and the fourth areas has

rectangular shape.

A rectangular shape may provide an efficient implementation for such areas.

For example, at least one of the default sample value and the default feature value is equal to zero.

Removing noise from samples and values of features within an area may improve subsequent processing, especially for small samples/values close to zero.

According to an embodiment a method is provided for encoding a signal into a bitstream, comprising: obtaining a prediction signal; obtaining a residual signal from the signal and the prediction signal; processing the signal and the prediction signal by applying one or more layers of a neural network, thus obtaining a set of features; encoding the set of features and the residual signal into the bitstream.

The method considers a generalized residual signal, i.e. a set of features, in combination with a prediction signal to encode a signal into the bitstream. The signal and the prediction signal are processed by layers of a neural network to obtain a generalized residual. Such operation may be referred to as “generalized difference”, as the corresponding decoding method may reconstruct the signal by combining the generalized residual and the prediction signal. Such a non-linear, non-local operation may utilize additional redundancies in the signal and the prediction signal. Thus, the size of the bitstream may be reduced.

In an exemplary implementation, the neural network is a convolutional neural network.

A convolutional neural network may provide an efficient implementation of a neural network.

For example, the encoding is performed by an encoder of an autoencoder.

The coding may be readily and advantageously applied to effectively reduce the data rate, e.g. when transmission or storage of pictures or videos is desired. The processing by an autoencoder to encode/decode a signal may detect additional redundancies in the data to be encoded.

In an exemplary implementation, a training of the neural network and the autoencoder is performed in an end-to-end manner.

A training of the network performing the generalized difference and the autoencoder may lead to an improved encoding/decoding performance.

For example, the encoding is performed by a hybrid block-based encoder.

A generalized residual may be readily and advantageously applied in combination with a hybrid block-based encoder and decoder may improve the coding rate.

In an exemplary implementation, the encoding includes applying one or more of a hyperprior, an autoregressive model, and a factorized entropy model.

Introducing a hyper-prior and/or an autoregressive model, and/or a factorized entropy model may further improve the probability model and thus the coding rate by determining further redundancy in the data to be encoded.

For example, the signal to be encoded is a current frame.

A current frame of image or video data may be encoded and decoded efficiently by utilizing a generalized residual.

In an exemplary implementation, the prediction signal is obtained from at least one previous frame and at least one motion field.

Obtaining the prediction signal by utilizing at least one previous frame and at least one motion field may lead to a more refined prediction signal, thus improving the performance of encoding/decoding.

For example, the signal to be encoded is a current motion field.

A current motion field related to image or video data may be encoded and decoded efficiently by utilizing a generalized residual.

In an exemplary implementation, the prediction signal is obtained from at least one previous motion field.

Obtaining the prediction signal by utilizing at least one previous motion field may lead to a more refined prediction signal, thus improving the performance of encoding/decoding.

For example, the residual signal represents an area, and prior to the encoding the residual signal into the bitstream the following steps are performed: determining whether or not to set samples of the residual signal within a first area included in said area equal to a default sample value, encoding a first flag into the bitstream, the first flag indicating whether or not said samples are set equal to the default sample value.

Setting samples within an area to a default value may lead to an adapted probability

model for the encoding and thus further reduce the coding rate. A flag encoded into the bitstream may improve the processing following the decoding by removing noise.

In an exemplary implementation, the first area has rectangular shape.

A rectangular shape may provide an efficient implementation for such an area.

For example, the default sample value is equal to zero.

Setting the default value to zero may reduce the coding rate for areas including

sample values close to zero.

In an exemplary implementation, the set of features represents an area, and prior to the encoding the set of features into the bitstream the following steps are performed: determining whether or not to set values of the features within a second area included in said area equal to a default feature value, encoding a second flag into the bitstream, the second flag indicating whether or not said samples are equal to the default feature value.

Setting values of features within an area to a default value may lead to an adapted probability model for the encoding and thus further reduce the coding rate. A flag encoded into the bitstream may improve the processing following the decoding by removing noise.

For example, the second area has rectangular shape.

A rectangular shape may provide an efficient implementation for such an area.

In an exemplary implementation, the default feature value is equal to zero.

Setting the default value to zero may reduce the coding rate for areas including values of features close to zero.

For example, the residual signal represents an area, the set of features represents the area, and prior to the encoding the set of features and the residual signal into the bitstream the following steps are performed: determining whether or not to set samples of the residual signal within a third area included in said area equal to a default sample value and values of the features within a fourth area included in said area equal to an default feature value, encoding a third flag into the bitstream, the third flag indicating whether or not said samples and said values are set equal to the default sample value and to the default feature value, respectively.

Setting samples within a third area and values of features within a fourth area to a respective default value may lead to an adapted probability model for the encoding and thus further reduce the coding rate. A flag encoded into the bitstream may improve the processing following the decoding by removing noise.

In an exemplary implementation, at least one of the third and the fourth areas has rectangular shape.

A rectangular shape may provide an efficient implementation for such areas.

For example, at least one of the default sample value and the default feature value is equal to zero.

Setting the default value to zero may reduce the coding rate for areas including samples close to zero and for areas including values of features close to zero.

In an exemplary implementation, a computer program stored on a non-transitory medium and including code instructions, which, when executed on one or more processors, cause the one or more processors to execute steps of the method according to any of the methods described above.

According to an embodiment, an apparatus is provided for decoding a signal into a bitstream, comprising: processing circuitry configured to: decode from the bitstream a set of features and a residual signal; obtain a prediction signal; output the signal including determine whether to output a first reconstructed signal or a second reconstructed signal, or combine the first reconstructed signal and the second reconstructed signal; wherein the first reconstructed signal is based on the residual signal and the prediction signal; and the second reconstructed signal is obtained by processing the set of features and the prediction signal by applying one or more layers of a neural network.

According to an embodiment, an apparatus is provided for encoding a signal into a bitstream, comprising: processing circuitry configured to: obtain a prediction signal; obtain a residual signal from the signal and the prediction signal; process the signal and the prediction signal by applying one or more layers of a neural network, thus obtaining a set of features; encode the set of features and the residual signal into the bitstream.

The apparatuses provide the advantages of the methods described above.

The invention can be implemented in hardware (HW) and/or software (SW) or in any combination thereof. Moreover, HW-based implementations may be combined with SW-based implementations.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the invention are described in more detail with reference to the attached figures and drawings, in which:

FIG. 1 is a block diagram illustrating an exemplary network architecture for encoder and decoder side including a hyper prior model.

FIG. 2 is a block diagram illustrating a general network architecture for encoder side including a hyper prior model.

FIG. 3 is a block diagram illustrating a general network architecture for decoder side including a hyper prior model.

FIG. 4 is a schematic drawing illustrating a general scheme of an encoder and decoder based on a neural network.

FIG. 5 is a block diagram illustrating encoding of some embodiments in a picture encoding.

FIG. 6 is a block diagram illustrating decoding of some embodiments in a picture decoding.

FIG. 7 is a block diagram illustrating encoding and decoding using a generalized difference and a generalized sum.

FIG. 8 is a block diagram illustrating exemplarily tensor dimensions during encoding and decoding using a generalized difference and a generalized sum.

FIG. 9 is a block diagram illustrating exemplarily a switch to determine which reconstructed signal is to be outputted.

FIG. 10 is a block diagram illustrating exemplarily combining the first and the second reconstructed signal.

FIG. 11 is a block diagram illustrating encoding side and decoding side neural network with an exemplary numbering of layers.

FIG. 12 is a schematic drawing illustrating areas within a frame on which a determination or a combination are performed.

FIG. 13 is a block diagram illustrating an exemplary implementation for the generalized sum.

FIG. 14 is a flow diagram illustrating an exemplary encoding method.

FIG. 15 is a flow diagram illustrating an exemplary decoding method.

FIG. 16 is a block diagram showing an example of a video coding system configured to implement embodiments.

FIG. 17 is a block diagram showing another example of a video coding system configured to implement embodiments.

FIG. 18 is a block diagram illustrating an example of an encoding apparatus or a decoding apparatus.

FIG. 19 is a block diagram illustrating another example of an encoding apparatus or a decoding apparatus.

### DETAILED DESCRIPTION

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is understood that a disclosure in connection with a described method may also hold true for a corresponding device or system configured to perform the method and vice versa. For example, if one or a plurality of specific method steps is described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

Video coding typically refers to the processing of a sequence of pictures, which form the video or video sequence. Instead of the term picture the terms frame or image may be used as synonyms in the field of video coding. Video coding comprises two parts, video encoding and video decoding. Video encoding is performed at the source side, typically comprising processing (e.g. by compression) the original video pictures to reduce the amount of data required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general, as will be explained later) shall be understood to relate to both, “encoding” and “decoding” of video pictures. The combination of the encoding part and the decoding part is also referred to as CODEC (COding and DECoding).

In case of lossless video coding, the original video pictures can be reconstructed, i.e. the reconstructed video pictures have the same quality as the original video pictures (assuming no transmission errors or other data loss during storage or transmission). In case of lossy video coding, further compression, e.g. by quantization, is performed, to reduce the amount of data representing the video pictures, which cannot be completely reconstructed at the decoder, i.e. the quality of the reconstructed video pictures is lower or worse compared to the quality of the original video pictures.

Several H.26x video coding standards (e.g. H.261, H.263, H.264, H.265, H.266) are used for “lossy hybrid video coding” (that is, spatial and temporal prediction in a sample domain is combined with 2D transform coding for applying quantization in a transform domain). Each picture of a video sequence is typically partitioned into a set of non-overlapping blocks, and coding is typically performed at a block level. To be specific, at an encoder side, a video is usually processed, that is, encoded, at a block (video block) level. For example, a prediction block is generated through spatial (intra-picture) prediction and temporal (inter-picture) prediction, the prediction block is subtracted from a current block (block being processed or to be processed) to obtain a residual block, and the residual block is transformed in the transform domain and quantized to reduce an amount of data that is to be transmitted (compressed). At a decoder side, an inverse processing part relative to the encoder is applied to an encoded block or a compressed block to reconstruct the current block for representation. Furthermore, the encoder duplicates the decoder processing loop such that both generate identical predictions (for example, intra-and inter predictions) and/or re-constructions for processing, that is, coding, the subsequent blocks.

The present disclosure relates to processing picture and/or video data using a neural network for the purpose of encoding and decoding of the picture and/or video data. Such encoding and decoding may still refer to or comprise some components know from the framework of the above-mentioned standards.

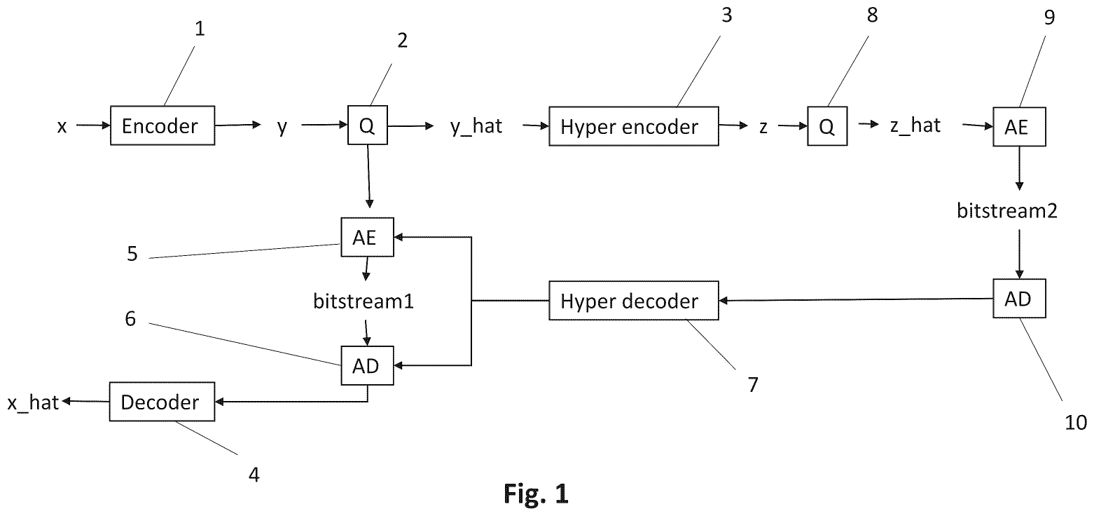

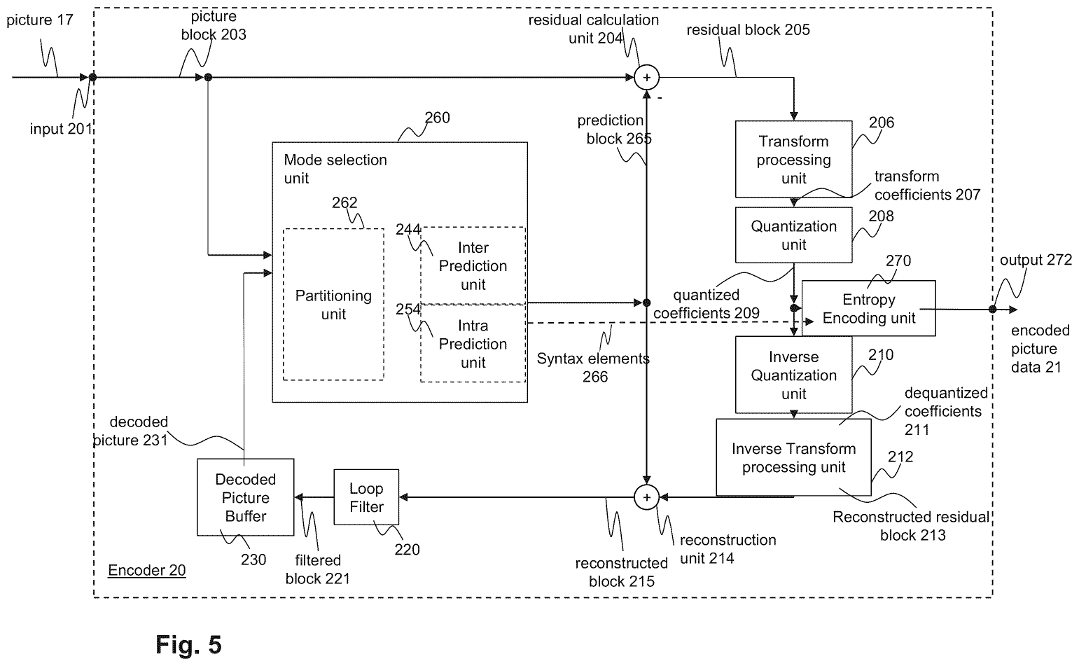

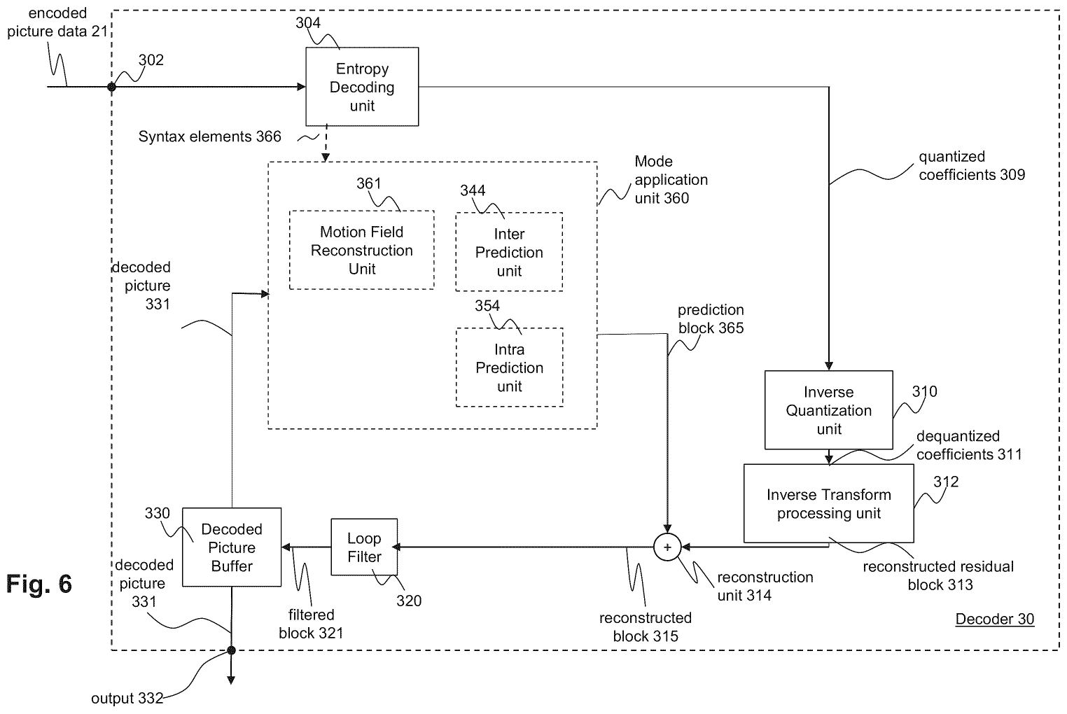

The encoding (decoding) of a signal may be performed for example by an encoding (decoding) neural network of an autoencoder. An exemplary implementation of such an autoencoder is provided in the following with reference to FIGS. 1 to 4. The encoding (decoding) of a signal may be performed by a hybrid block-based encoder (decoder), which is explained in detail with references to FIGS. 5 and 6.

### Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

### (1) Deep Neural Network

The deep neural network (deep neural network, DNN), also referred to as a multi-layer neural network, may be understood as a neural network having many hidden layers. The “many” herein does not have a special measurement standard. The DNN is divided based on locations of different layers, and a neural network in the DNN may be divided into three types: an input layer, a hidden layer, and an output layer. Generally, the first layer is the input layer, the last layer is the output layer, and the middle layer is the hidden layer. Layers are fully connected. To be specific, any neuron at the i^{th} layer is certainly connected to any neuron at the (i+1)^{th} layer. Although the DNN seems to be complex, the DNN is actually not complex in terms of work at each layer, and is simply expressed as the following linear relationship expression: \vec{y}=α(W\vec{x}+\vec{b}), where \vec{x} is an input vector, \vec{y} is an output vector, \vec{b} is a bias vector, W is a weight matrix (also referred to as a coefficient), and α( ) is an activation function. At each layer, the output vector \vec{y} is obtained by performing such a simple operation on the input vector \vec{x}. Because there are many layers in the DNN, there are also many coefficients W and bias vectors \vec{b}. Definitions of these parameters in the DNN are as follows: The coefficient W is used as an example. It is assumed that in a three-layer DNN, a linear coefficient from the fourth neuron at the second layer to the second neuron at the third layer is defined as W₂₄³. The superscript 3 represents a layer at which the coefficient w is located, and the subscript corresponds to an output third-layer index 2 nd an input second-layer index 4. In conclusion, a coefficient from the k^{th} neuron at the (L-1)^{th} layer to the j^{th} neuron at the L^{th} layer is defined as Wⱼ^{L}. It should be noted that there is no parameter W at the input layer. In the deep neural network, more hidden layers make the network more capable of describing a complex case in the real world. Theoretically, a model with a larger quantity of parameters indicates higher complexity and a larger “capacity”, and indicates that the model can complete a more complex learning task. Training the deep neural network is a process of learning a weight matrix, and a final objective of the training is to obtain a weight matrix of all layers of the trained deep neural network (a weight matrix formed by vectors W at many layers).

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting

### (2) Convolutional Neural Network

A convolutional neural network (convolutional neuron network, CNN) is a deep neural network with a convolutional structure, and is a deep learning (deep learning) architecture. In the deep learning architecture, multi-layer learning is performed at different abstract levels by using a machine learning algorithm. As a deep learning architecture, the CNN is a feed-forward (feed-forward) artificial neural network. A neuron in the feed-forward artificial neural network may respond to a picture input into the neuron. The convolutional neural network includes a feature extractor constituted by a convolutional layer and a pooling layer. The feature extractor may be considered as a filter. A convolution process may be considered as using a trainable filter to perform convolution on an input image or a convolutional feature plane (feature map).

The convolutional layer is a neuron layer that is in the convolutional neural network and at which convolution processing is performed on an input signal. The convolutional layer 221 may include a plurality of convolution operators. The convolution operator is also referred to as a kernel. In image processing, the convolution operator functions as a filter that extracts specific information from an input image matrix. The convolution operator may essentially be a weight matrix, and the weight matrix is usually predefined. In a process of performing a convolution operation on an image, the weight matrix usually processes pixels at a granularity level of one pixel (or two pixels, depending on a value of a stride (stride)) in a horizontal direction on the input image, to extract a specific feature from the image. A size of the weight matrix should be related to a size of the picture. It should be noted that a depth dimension (depth dimension) of the weight matrix is the same as a depth dimension of the input picture. During a convolution operation, the weight matrix extends to an entire depth of the input picture. Therefore, a convolutional output of a single depth dimension is generated through convolution with a single weight matrix. However, in most cases, a single weight matrix is not used, but a plurality of weight matrices with a same size (rows×columns), namely, a plurality of same-type matrices, are applied. Outputs of the weight matrices are stacked to form a depth dimension of a convolutional picture. The dimension herein may be understood as being determined based on the foregoing “plurality”. Different weight matrices may be used to extract different features from the picture. For example, one weight matrix is used to extract edge information of the picture, another weight matrix is used to extract a specific color of the picture, and a further weight matrix is used to blur unneeded noise in the picture. Sizes of the plurality of weight matrices (rows×columns) are the same. Sizes of feature maps extracted from the plurality of weight matrices with the same size are also the same, and then the plurality of extracted feature maps with the same size are combined to form an output of the convolution operation. Weight values in these weight matrices need to be obtained through massive training in actual application. Each weight matrix formed by using the weight values obtained through training may be used to extract information from the input image, to enable the convolutional neural network to perform correct prediction. When the convolutional neural network has a plurality of convolutional layers, a relatively large quantity of general features are usually extracted at an initial convolutional layer. The general feature may also be referred to as a low-level feature. As a depth of the convolutional neural network increases, a feature extracted at a subsequent convolutional layer is more complex, for example, a high-level semantic feature. A feature with higher-level semantics is more applicable to a to-be-resolved problem.

A quantity of training parameters often needs to be reduced. Therefore, a pooling layer often needs to be periodically introduced after a convolutional layer. One convolutional layer may be followed by one pooling layer, or a plurality of convolutional layers may be followed by one or more pooling layers. During picture processing, the pooling layer is only used to reduce a space size of the picture. The pooling layer may include an average pooling operator and/or a maximum pooling operator, to perform sampling on the input picture to obtain a picture with a relatively small size. The average pooling operator may be used to calculate pixel values in the picture in a specific range, to generate an average value. The average value is used as an average pooling result. The maximum pooling operator may be used to select a pixel with a maximum value in a specific range as a maximum pooling result. In addition, similar to that the size of the weight matrix at the convolutional layer needs to be related to the size of the picture, an operator at the pooling layer also needs to be related to the size of the picture. A size of a processed picture output from the pooling layer may be less than a size of a picture input to the pooling layer. Each pixel in the picture output from the pooling layer represents an average value or a maximum value of a corresponding sub-region of the picture input to the pooling layer.

After processing performed at the convolutional layer/pooling layer, the convolutional neural network is not ready to output required output information, because as described above, at the convolutional layer/pooling layer, only a feature is extracted, and parameters resulting from the input image are reduced. However, to generate final output information (required class information or other related information), the convolutional neural network needs to use the neural network layer to generate an output of one required class or a group of required classes. Therefore, the convolutional neural network layer may include a plurality of hidden layers. Parameters included in the plurality of hidden layers may be obtained through pre-training based on related training data of a specific task type. For example, the task type may include image recognition, image classification, and super-resolution image reconstruction.

Optionally, at the neural network layer, the plurality of hidden layers are followed by the output layer of the entire convolutional neural network. The output layer has a loss function similar to a categorical cross entropy, and the loss function is specifically used to calculate a prediction error. Once forward propagation of the entire convolutional neural network is completed, backward propagation is started to update a weight value and a deviation of each layer mentioned above, to reduce a loss of the convolutional neural network and an error between a result output by the convolutional neural network by using the output layer and an ideal result.

### (3) Recurrent Neural Network

A recurrent neural network (recurrent neural network, RNN) is used to process sequence data. In a conventional neural network model, from an input layer to a hidden layer and then to an output layer, the layers are fully connected, and nodes at each layer are not connected. Such a common neural network resolves many difficult problems, but is still incapable of resolving many other problems. For example, if a word in a sentence is to be predicted, a previous word usually needs to be used, because adjacent words in the sentence are not independent. A reason why the RNN is referred to as the recurrent neural network is that a current output of a sequence is also related to a previous output of the sequence. A specific representation form is that the network memorizes previous information and applies the previous information to calculation of the current output. To be specific, nodes at the hidden layer are connected, and an input of the hidden layer not only includes an output of the input layer, but also includes an output of the hidden layer at a previous moment. Theoretically, the RNN can process sequence data of any length. Training for the RNN is the same as training for a conventional CNN or DNN. An error backward propagation algorithm is also used, but there is a difference: If the RNN is expanded, a parameter such as W of the RNN is shared. This is different from the conventional neural network described in the foregoing example. In addition, during use of a gradient descent algorithm, an output in each step depends not only on a network in a current step, but also on a network status in several previous steps. The learning algorithm is referred to as a backward propagation through time (backward propagation through time, BPTT) algorithm.

### Variational Auto-Encoder (VAE)

An exemplary deep learning based image and video compression algorithm follows the Variational Auto-Encoder (VAE) framework, e.g. Z. Cui, J. Wang, B. Bai, T. Guo, Y. Feng, “G-VAE: A Continuously Variable Rate Deep Image Compression Framework”, arXiv preprint arXiv:2003.02012, 2020.

FIG. 1 exemplifies the VAE framework. The VAE framework could be considered as a nonlinear transforming coding model. At the encoder side of the network, an encoder 1 maps an image x into a latent representation via the function y=f(x). The encoder may include or consist of a neural network. A quantizer 2 transforms the latent representation into discrete values, y_hat=Q(y) of a desired bitlength and/or precision. The quantized signal (latent space) y_hat is included into a bitstream (bitstream1) using arithmetic coding, denoted as AE standing for arithmetic encoder 5.

At the decoder side of the network, the encoded latent space is decoded from the bitstream by an arithmetic decoder AD 6. A decoder 4 that transforms the quantized latent representation which is output from the AD 6 into the decoded image, x_hat=g(y_hat). The decoder 4 may include or consist of a neural network.

In FIG. 1, two subnetworks are concatenated to each other. The first network comprises the above mentioned processing units 1 (encoder 1), 2 (quantizer), 4 (decoder), 5 (AE) and 6 (AD). At least the units 1, 2, and 4 are called the auto-encoder/decoder or simply the encoder/decoder network.

The second subnetwork comprises at least units 3 and 7 and is called a hyper encoder/decoder or context modeler. In particular, the second subnetwork models the probability model (context) for the AE 5 and the AD 6. An entropy model, or in this case the hyper encoder 3 estimates a distribution z of the quantized signal y_hat to come close to the minimum rate achievable with lossless entropy source coding. The estimated distribution is quantized by a quantizer 8 to obtain quantized probability model z_hat which represents side information that may be conveyed to the decoder side within a bitstream. In order to do so, an arithmetic encoder, AE 9 may encode the probability model into a bitstream2. Bitstream2 may be conveyed together with bitstream1 to the decoder side and provided also to the encoder. In particular, in order to be provided to the AE 5 and AD 6, the quantized probability model z_hat is arithmetically decoded by the AD 10 and then decoded with the hyper decoder 7 and inserted to AD6 and to AE 5.

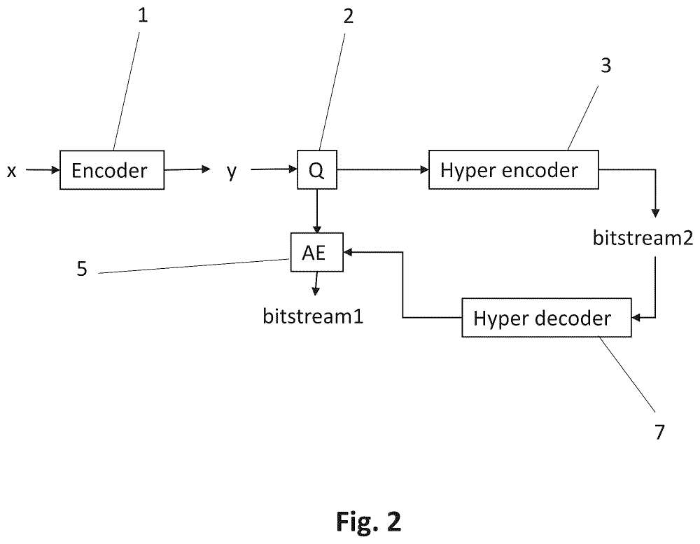

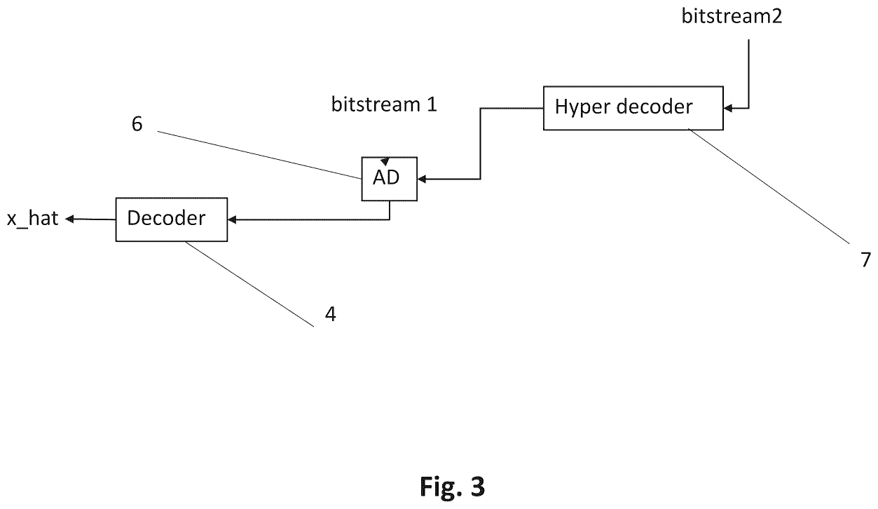

FIG. 1 depicts the encoder and the decoder in a single figure. On the other hand, FIGS. 2 and 3 shows an encoder and a decoder separately, as they may work separately. In other words, the encoder may generate the bitstream 1 and the bitstream2. The decoder may receive such bitstream from storage, or via a channel or the like and may decode it without any further communication with the encoder. The above description of the encoder and decoder elements applies also for FIGS. 2 and 3.

Majority of Deep Learning based image/video compression systems reduce dimensionality of the signal before converting the signal into binary digits (bits).

In the VAE framework, for example, the encoder which is a non-linear transform, maps the input image x into y, where y has a smaller width and height than x. Since the y has a smaller width and height, hence a smaller size, the dimension of the signal is reduced, and hence it is easier to compress the signal y.

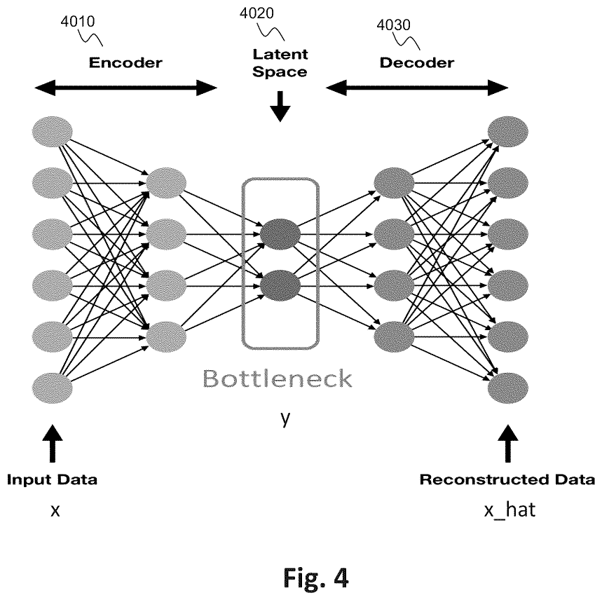

A general principle of compression is exemplified in FIG. 4. The input image x corresponds to the input data, which is the input of the encoder. The transformed signal y corresponds to the latent space, which has a smaller dimensionality than the input signal and is thus also referred to as bottleneck. Typically, the dimensionality of the channels is smallest at this processing position within the encoder-decoder pipeline. Each column of circles in FIG. 4 represents a layer in the processing chain of the encoder or decoder. The number of circles in each layer indicate the size or the dimensionality of the signal at that layer. The latent space, which is the output of the encoder and input of the decoder, represents the compressed data y. At the decoder side, the latent space signal y (encoded image) is processed by the decoder neural network, leading to expanding the dimensions of the channels, until obtaining the reconstructed data x_hat which may have the same dimensions as the input data x, but differ from the input data x especially in case the lossy processing has been applied. The dimensions of the channels processed by the decoder layers is typically higher than the bottleneck data y dimensions. In other words, usually, the encoding operation corresponds to reduction in the size of the input signal, whereas the decoding operation corresponds to reconstruction of the original size of the image-thus the name bottleneck.

As mentioned above, reduction of the signal size may be achieved by down-sampling or rescaling. The reduction in the signal size usually happens step by step along the chain of processing layers, not all at once. For example if the input image x has dimensions of h and w (indicating the height and the width), and the latent space y has dimensions h/16 and w/16, the reduction of size might happen at 4 layers during the encoding, wherein each layer reduces the size of the signal by a factor of 2 in each dimension.

### Hybrid Block-Based Encoder

One possible deployment can be seen in FIGS. 5 and 6.

FIG. 5 shows a schematic block diagram of an example video encoder 20 that is configured to implement the techniques of the present application. In the example of FIG. 5, the video encoder 20 comprises an input 201 (or input interface 201), a residual calculation unit 204, a transform processing unit 206, a quantization unit 208, an inverse quantization unit 210, and inverse transform processing unit 212, a reconstruction unit 214, a loop filter unit 220, a decoded picture buffer (DPB) 230, a mode selection unit 260, an entropy encoding unit 270 and an output 272 (or output interface 272).

The mode selection unit 260 may include an inter prediction unit 244, an intra prediction unit 254 and a partitioning unit 262. Inter prediction unit 244 may include a motion estimation unit and a motion compensation unit (not shown). Some embodiments of the present disclosure may relate to inter-prediction. In the motion estimation, part of the inter-prediction, the motion flow estimation 266 may be implemented, including, e.g. an optical flow (dense motion field) determination according any of the known approaches, motion field sparsification, segment determination, interpolation determination per segments, and indication of the interpolation information within a bitstream (e.g. via the entropy encoder 270). Inter prediction unit 244 performs prediction of the current frame based on the motion vectors (motion vector flow) determined in the motion estimation unit 266.

The residual calculation unit 204, the transform processing unit 206, the quantization unit 208, the mode selection unit 260 may be referred to as forming a forward signal path of the encoder 20, whereas the inverse quantization unit 210, the inverse transform processing unit 212, the reconstruction unit 214, the buffer 216, the loop filter 220, the decoded picture buffer (DPB) 230, the inter prediction unit 244 and the intra-prediction unit 254 may be referred to as forming a backward signal path of the video encoder 20, wherein the backward signal path of the video encoder 20 corresponds to the signal path of the decoder. The inverse quantization unit 210, the inverse transform processing unit 212, the reconstruction unit 214, the loop filter 220, the decoded picture buffer (DPB) 230, the inter prediction unit 244 and the intra-prediction unit 254 are also referred to forming the “built-in decoder” of video encoder 20. A video encoder 20 as shown in FIG. 5 may also be referred to as hybrid video encoder or a video encoder according to a hybrid video codec.

The encoder 20 may be configured to receive, e.g. via input 201, a picture 17 (or picture data 17), e.g. picture of a sequence of pictures forming a video or video sequence. The received picture or picture data may also be a pre-processed picture 19 (or pre-processed picture data 19). For sake of simplicity the following description refers to the picture 17. The picture 17 may also be referred to as current picture or picture to be coded (in particular in video coding to distinguish the current picture from other pictures, e.g. previously encoded and/or decoded pictures of the same video sequence, i.e. the video sequence which also comprises the current picture).

A (digital) picture is or can be regarded as a two-dimensional array or matrix of samples with intensity values. A sample in the array may also be referred to as pixel (short form of picture element) or a pel. The number of samples in horizontal and vertical direction (or axis) of the array or picture define the size and/or resolution of the picture. For representation of color, typically three color components are employed, i.e. the picture may be represented or include three sample arrays. In RGB format or color space a picture comprises a corresponding red, green and blue sample array. However, in video coding each pixel is typically represented in a luminance and chrominance format or color space, e.g. YCbCr, which comprises a luminance component indicated by Y (sometimes also L is used instead) and two chrominance components indicated by Cb and Cr. The luminance (or short luma) component Y represents the brightness or grey level intensity (e.g. like in a grey-scale picture), while the two chrominance (or short chroma) components Cb and Cr represent the chromaticity or color information components. Accordingly, a picture in YCbCr format comprises a luminance sample array of luminance sample values (Y), and two chrominance sample arrays of chrominance values (Cb and Cr). Pictures in RGB format may be converted or transformed into YCbCr format and vice versa, the process is also known as color transformation or conversion. If a picture is monochrome, the picture may comprise only a luminance sample array. Accordingly, a picture may be, for example, an array of luma samples in monochrome format or an array of luma samples and two corresponding arrays of chroma samples in 4:2:0, 4:2:2, and 4:4:4 color format.

Embodiments of the video encoder 20 as shown in FIG. 5 may be configured to encode the picture 17 block by block or per frame, e.g. the encoding and prediction may be performed per block 203. For example, the above-mentioned triangulation may be performed for some blocks (rectangular or square parts of the image) separately. Moreover, intra prediction may work on a block basis, possibly including partitioning to blocks of different sizes.

Embodiments of the video encoder 20 as shown in FIG. 5 may be further configured to partition and/or encode the picture using slices (also referred to as video slices), wherein a picture may be partitioned into or encoded using one or more slices (typically non-overlapping), and each slice may comprise one or more blocks (e.g. CTUs).

Embodiments of the video encoder 20 as shown in FIG. 5 may be further configured to partition and/or encode the picture using tile groups (also referred to as video tile groups) and/or tiles (also referred to as video tiles), wherein a picture may be partitioned into or encoded using one or more tile groups (typically non-overlapping), and each tile group may comprise, e.g. one or more blocks (e.g. CTUs) or one or more tiles, wherein each tile, e.g. may be of rectangular shape and may comprise one or more blocks (e.g. CTUs), e.g. complete or fractional blocks which may be coded in parallel.

The residual calculation unit 204 may be configured to calculate a residual block 205 (also referred to as residual 205) based on the picture block 203 and a prediction block 265 (further details about the prediction block 265 are provided later), e.g. by subtracting sample values of the prediction block 265 from sample values of the picture block 203, sample by sample (pixel by pixel) to obtain the residual block 205 in the sample domain.

The transform processing unit 206 may be configured to apply a transform, e.g. a discrete cosine transform (DCT) or discrete sine transform (DST), on the sample values of the residual block 205 to obtain transform coefficients 207 in a transform domain. The transform coefficients 207 may also be referred to as transform residual coefficients and represent the residual block 205 in the transform domain. The present disclosure may also apply other transformation, which may be content-adaptive such as KLT, or the like.

The transform processing unit 206 may be configured to apply integer approximations of DCT/DST, such as the transforms specified for H.265/HEVC. Compared to an orthogonal DCT transform, such integer approximations are typically scaled by a certain factor. In order to preserve the norm of the residual block which is processed by forward and inverse transforms, additional scaling factors are applied as part of the transform process. The scaling factors are typically chosen based on certain constraints like scaling factors being a power of two for shift operations, bit depth of the transform coefficients, tradeoff between accuracy and implementation costs, etc. Specific scaling factors are, for example, specified for the inverse transform, e.g. by inverse transform processing unit 212 (and the corresponding inverse transform, e.g. by inverse transform processing unit 312 at video decoder 30) and corresponding scaling factors for the forward transform, e.g. by transform processing unit 206, at an encoder 20 may be specified accordingly.

Embodiments of the video encoder 20 (respectively transform processing unit 206) may be configured to output transform parameters, e.g. a type of transform or transforms, e.g. directly or encoded or compressed via the entropy encoding unit 270, so that, e.g., the video decoder 30 may receive and use the transform parameters for decoding.

The quantization unit 208 may be configured to quantize the transform coefficients 207 to obtain quantized coefficients 209, e.g. by applying scalar quantization or vector quantization. The quantized coefficients 209 may also be referred to as quantized transform coefficients 209 or quantized residual coefficients 209.

The quantization process may reduce the bit depth associated with some or all of the transform coefficients 207. For example, an n-bit transform coefficient may be rounded down to an m-bit Transform coefficient during quantization, where n is greater than m. The degree of quantization may be modified by adjusting a quantization parameter (QP). For example for scalar quantization, different scaling may be applied to achieve finer or coarser quantization. Smaller quantization step sizes correspond to finer quantization, whereas larger quantization step sizes correspond to coarser quantization. The applicable quantization step size may be indicated by a quantization parameter (QP). The quantization parameter may for example be an index to a predefined set of applicable quantization step sizes. For example, small quantization parameters may correspond to fine quantization (small quantization step sizes) and large quantization parameters may correspond to coarse quantization (large quantization step sizes) or vice versa. The quantization may include division by a quantization step size and a corresponding and/or the inverse dequantization, e.g. by inverse quantization unit 210, may include multiplication by the quantization step size. Embodiments according to some standards, e.g. HEVC, may be configured to use a quantization parameter to determine the quantization step size. Generally, the quantization step size may be calculated based on a quantization parameter using a fixed point approximation of an equation including division. Additional scaling factors may be introduced for quantization and dequantization to restore the norm of the residual block, which might get modified because of the scaling used in the fixed point approximation of the equation for quantization step size and quantization parameter. In one example implementation, the scaling of the inverse transform and dequantization might be combined. Alternatively, customized quantization tables may be used and signaled from an encoder to a decoder, e.g. in a bitstream. The quantization is a lossy operation, wherein the loss increases with increasing quantization step sizes.

A picture compression level is controlled by quantization parameter (QP) that may be fixed for the whole picture (e.g. by using a same quantization parameter value), or may have different quantization parameter values for different regions of the picture.

FIG. 6 shows an example of a video decoder 30 that is configured to implement the techniques of this present application. The video decoder 30 is configured to receive encoded picture data 21 (e.g. encoded bitstream 21), e.g. encoded by encoder 20, to obtain a decoded picture 331. The encoded picture data or bitstream comprises information for decoding the encoded picture data, e.g. data that represents picture blocks of an encoded video slice (and/or tile groups or tiles) and associated syntax elements.

In the example of FIG. 6, the decoder 30 comprises an entropy decoding unit 304, an inverse quantization unit 310, an inverse transform processing unit 312, a reconstruction unit 314 (e.g. a summer 314), a loop filter 320, a decoded picture buffer (DBP) 330, a mode application unit 360, an inter prediction unit 344 and an intra prediction unit 354. Inter prediction unit 344 may be or include a motion compensation unit. Video decoder 30 may, in some examples, perform a decoding pass generally reciprocal to the encoding pass described with respect to video encoder 100 from FIG. 5.

As explained with regard to the encoder 20, the inverse quantization unit 210, the inverse transform processing unit 212, the reconstruction unit 214 the loop filter 220, the decoded picture buffer (DPB) 230, the inter prediction unit 344 and the intra prediction unit 354 are also referred to as forming the “built-in decoder” of video encoder 20. Accordingly, the inverse quantization unit 310 may be identical in function to the inverse quantization unit 110, the inverse transform processing unit 312 may be identical in function to the inverse transform processing unit 212, the reconstruction unit 314 may be identical in function to reconstruction unit 214, the loop filter 320 may be identical in function to the loop filter 220, and the decoded picture buffer 330 may be identical in function to the decoded picture buffer 230. Therefore, the explanations provided for the respective units and functions of the video 20 encoder apply correspondingly to the respective units and functions of the video decoder 30.

The entropy decoding unit 304 is configured to parse the bitstream 21 (or in general encoded picture data 21) and perform, for example, entropy decoding to the encoded picture data 21 to obtain, e.g., quantized coefficients 309 and/or decoded coding parameters (not shown in FIG. 6), e.g. any or all of inter prediction parameters (e.g. reference picture index and motion vectors or further parameters such as the interpolation information), intra prediction parameter (e.g. intra prediction mode or index), transform parameters, quantization parameters, loop filter parameters, and/or other syntax elements. Entropy decoding unit 304 maybe configured to apply the decoding algorithms or schemes corresponding to the encoding schemes as described with regard to the entropy encoding unit 270 of the encoder 20. Entropy decoding unit 304 may be further configured to provide inter prediction parameters, intra prediction parameter and/or other syntax elements to the mode application unit 360 and other parameters to other units of the decoder 30. Video decoder 30 may receive the syntax elements at the video slice level and/or the video block level. In addition or as an alternative to slices and respective syntax elements, tile groups and/or tiles and respective syntax elements may be received and/or used.

The inverse quantization unit 310 may be configured to receive quantization parameters (QP) (or in general information related to the inverse quantization) and quantized coefficients from the encoded picture data 21 (e.g. by parsing and/or decoding, e.g. by entropy decoding unit 304) and to apply based on the quantization parameters an inverse quantization on the decoded quantized coefficients 309 to obtain dequantized coefficients 311, which may also be referred to as transform coefficients 311. The inverse quantization process may include use of a quantization parameter determined by video encoder 20 for each video block in the video slice (or tile or tile group) to determine a degree of quantization and, likewise, a degree of inverse quantization that should be applied.

Inverse transform processing unit 312 may be configured to receive dequantized coefficients 311, also referred to as transform coefficients 311, and to apply a transform to the dequantized coefficients 311 in order to obtain reconstructed residual blocks 213 in the sample domain. The reconstructed residual blocks 213 may also be referred to as transform blocks 313. The transform may be an inverse transform, e.g., an inverse DCT, an inverse DST, an inverse integer transform, or a conceptually similar inverse transform process. The inverse transform processing unit 312 may be further configured to receive transform parameters or corresponding information from the encoded picture data 21 (e.g. by parsing and/or decoding, e.g. by entropy decoding unit 304) to determine the transform to be applied to the dequantized coefficients 311.

The reconstruction unit 314 (e.g. adder or summer 314) may be configured to add the reconstructed residual block 313, to the prediction block 365 to obtain a reconstructed block 315 in the sample domain, e.g. by adding the sample values of the reconstructed residual block 313 and the sample values of the prediction block 365.

The loop filter unit 320 (either in the coding loop or after the coding loop) is configured to filter the reconstructed block 315 to obtain a filtered block 321, e.g. to smooth pixel transitions, or otherwise improve the video quality. The loop filter unit 320 may comprise one or more loop filters such as a de-blocking filter, a sample-adaptive offset (SAO) filter or one or more other filters, e.g. a bilateral filter, an adaptive loop filter (ALF), a sharpening, a smoothing filters or a collaborative filters, or any combination thereof. Although the loop filter unit 320 is shown in FIG. 6 as being an in loop filter, in other configurations, the loop filter unit 320 may be implemented as a post loop filter.

The decoded video blocks 321 of a picture are then stored in decoded picture buffer 330, which stores the decoded pictures 331 as reference pictures for subsequent motion compensation for other pictures and/or for output respectively display.

The decoder 30 is configured to output the decoded picture 311, e.g. via output 312, for presentation or viewing to a user.

The inter prediction unit 344 may be identical to the inter prediction unit 244 and the intra prediction unit 354 may be identical to the intra prediction unit 254 in function. The intra prediction unit 254 may perform split or partitioning of the picture and prediction based on the partitioning and/or prediction parameters or respective information received from the encoded picture data 21 (e.g. by parsing and/or decoding, e.g. by entropy decoding unit 304). Inter-prediction relies on the prediction obtained by reconstructing the motion vector field by the unit 358, based on the (e.g. also entropy decoded) interpolation information. Mode application unit 360 may be configured to perform the prediction (intra or inter prediction) per block based on reconstructed pictures, blocks or respective samples (filtered or unfiltered) to obtain the prediction block 365.

When the video slice is coded as an intra coded (I) slice, intra prediction unit 354 of mode application unit 360 is configured to generate prediction block 365 for a picture block of the current video slice based on a signaled intra prediction mode and data from previously decoded blocks of the current picture. When the video picture is coded as an inter coded (i.e., B, or P) slice, inter prediction unit 344 (e.g. motion compensation unit) of mode application unit 360 is configured to produce prediction blocks 365 for a video block of the current video slice based on the motion vectors and other syntax elements received from entropy decoding unit 304. For inter prediction, the prediction blocks may be produced from one of the reference pictures within one of the reference picture lists. The same or similar may be applied for or by embodiments using tile groups (e.g. video tile groups) and/or tiles (e.g. video tiles) in addition or alternatively to slices (e.g. video slices), e.g. a video may be coded using I, P or B tile groups and/or tiles.

Mode application unit 360 is configured to determine the prediction information for a video block of the current video slice by parsing the motion vectors or related information and other syntax elements, and uses the prediction information to produce the prediction blocks for the current video block being decoded. For example, the mode application unit 360 uses some of the received syntax elements to determine a prediction mode (e.g., intra or inter prediction) used to code the video blocks of the video slice, an inter prediction slice type (e.g., B slice, P slice, or GPB slice), construction information for one or more of the reference picture lists for the slice, motion vectors for each determined sample position associated with a motion vector and located in the slice, and other information to decode the video blocks in the current video slice. The same or similar may be applied for or by embodiments using tile groups (e.g. video tile groups) and/or tiles (e.g. video tiles) in addition or alternatively to slices (e.g. video slices), e.g. a video may be coded using I, P or B tile groups and/or tiles.

Other variations of the video decoder 30 can be used to decode the encoded picture data 21. For example, the decoder 30 can produce the output video stream without the loop filtering unit 320. For example, a non-transform based decoder 30 can inverse-quantize the residual signal directly without the inverse-transform processing unit 312 for certain blocks or frames. In another implementation, the video decoder 30 can have the inverse-quantization unit 310 and the inverse-transform processing unit 312 combined into a single unit.

It should be understood that, in the encoder 20 and the decoder 30, a processing result of a current step may be further processed and then output to the next step. For example, after interpolation filtering, motion vector derivation or loop filtering, a further operation, such as Clip or shift, may be performed on the processing result of the interpolation filtering, motion vector derivation or loop filtering.

### Prediction Signals Using Motion Fields

A motion vector is typically understood as a 2D-vector that specifies the spatial distance between two corresponding points in two different video frames, usually denoted as v =[vₓ, v_{y}]. An MV is commonly used abbreviation for motion vector. However, the term “motion vector” may have more dimensions. For example, a reference picture may be an additional (temporal) coordinate. The term “MV coordinate” or “MV position” denotes a position of a pixel (of which the motion is given by the motion vector) or motion vector origin. Denoted as p=[x,y]. A motion field is a set of (p,v/pairs. It may be denoted as M or abbreviated as MF. A dense motion field is a motion field, which covers every pixel of an image. Here, p may be redundant, if the dimensions of the image are known, since the motion vectors can be ordered in line-scan order or in any predefined order. A sparse motion field is a motion field that does not cover all pixels. Here, knowing p may be necessary in some scenarios. A reconstructed motion field is a dense motion field, which was reconstructed from a sparse motion field. The term current frame denotes a frame to be encoded, e.g. a frame which is currently predicted in case of the inter prediction. A reference frame is a frame that is used as a reference for temporal prediction.

Motion compensation is a term referring to generating a predicted image using a reference frame and motion information (e.g. a dense motion field may be reconstructed and applied for that). Inter-Prediction is a temporal prediction in video coding in which motion information is signaled to the decoder such that it can generate a predicted image using previously decoded one or more frames. The term frame denotes in video coding a video picture (which may be also referred to as image). A video picture includes typically a plurality of samples (which are also referred to as pixels) representing a brightness level. A frame (picture) has typically a rectangular shape and it may have one or more channels such as color channels and/or other channels (e.g. depth).

Some newer optical flow based algorithms generate a dense motion field. This motion field consists of many motion vectors, one for each pixel in the image. Using this motion field for prediction usually yields a much better prediction quality than hierarchic block-based prediction. However, since the dense motion field contains as many motion vectors as the image has samples (e.g. pixels), it is not feasible to transmit (or store) the whole field, since the motion field may contain more information than the image itself. Therefore, the dense motion field would usually be sub-sampled, quantized, and then inserted (encoded) into the bitstream. The decoder then interpolates the missing (due to subsampling) motion vectors and uses the reconstructed dense motion field for motion compensation. The reconstruction of the (dense) optical flow means reconstructing motion vectors for sample positions within the image, which do not belong to the set of sample positions associated with motion vectors indicated in the bitstream, based on the sample positions of the set.

### Residual Signals and Generalized Residual Signals

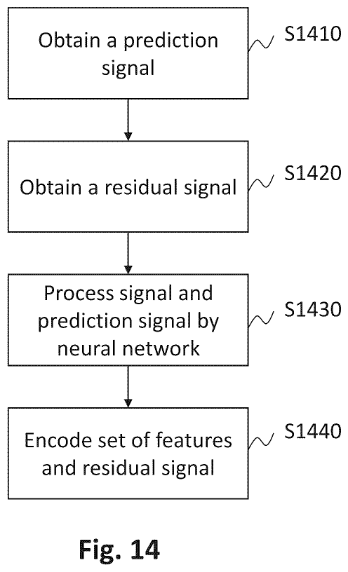

Encoding a residual signal is a common approach, for example, in video compression. A residual signal represents a difference between a current signal (actual signal to be encoded) and a reference signal, for example a predicted signal (prediction of the current signal). The encoding according to an embodiment is described by the flowchart in FIG. 14. A signal to be encoded may be a current frame or a part of the current frame. In general, the signal to be encoded may be a signal related to image data or video data. For example, the signal to be encoded may be a current motion field. However, the present disclosure is not limited to these examples. Any signal related to an image or a video may be encoded. Such a signal may represent a tensor of samples, i.e. a two or more dimensional, discrete tensor. In an exemplary implementation, such a tensor may have a shape of C×H×W, where C is number of channels, equal for example to 3, and H refers to the height and W refers to the width of an image to be encoded.

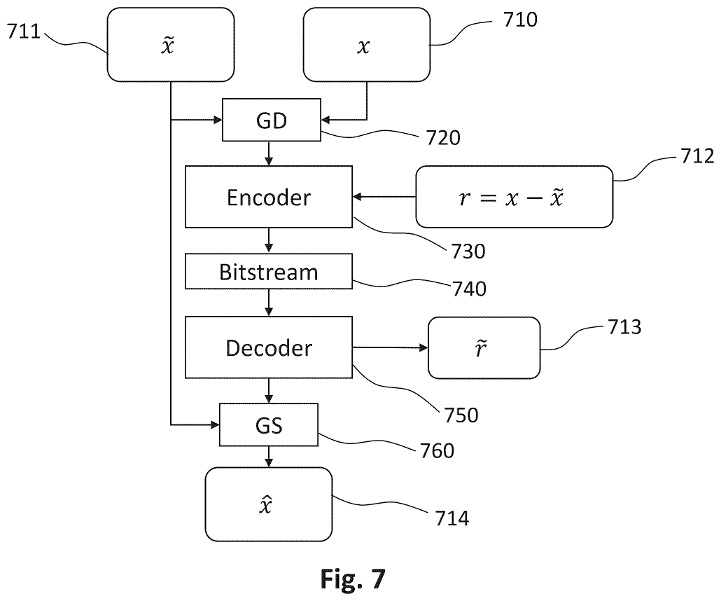

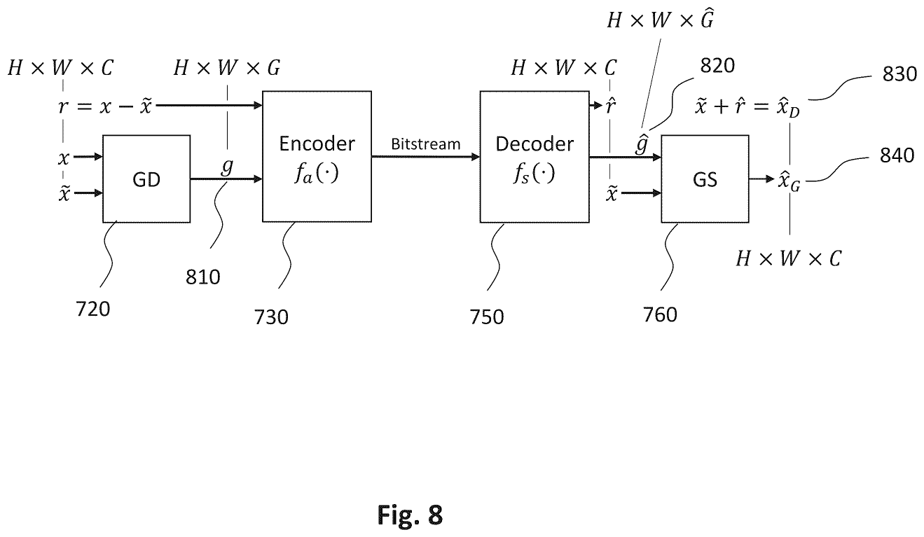

FIGS. 7 and 8 provide schematic diagrams illustrating the encoding according to the present embodiment. To encode a signal x into a bitstream, a prediction signal \tilde{x} 711 is obtained S1410. Such a prediction signal is obtained, for example, by using at least one previous signal, i.e. a signal previously processed in the encoding order. In the exemplary case, when the signal to be encoded is a current frame, the prediction signal may be obtained from one or more previous frames, i.e. frames preceding current frame in the encoding order. The prediction signal may be obtained by combining the one or more previous frames. Before combination, the one or more frames may be motion compensated by using motion vectors (motion field). This can be seen as a combination of the one or more frames with at least one motion field as also explained above in section Prediction signals using motion fields.

In the exemplary case, when the signal to be encoded is a current motion field, the prediction signal may be obtained from at least one previous motion field. Such a previous motion field may be processed previously in the encoding order with respect to the motion field that is currently encoded.

After obtaining a prediction signal, a residual signal r 712 is obtained S1420 from the signal x 710 and the prediction signal \tilde{x} 711. The residual signal 712 is obtained for example, by subtraction r=x−\tilde{x}, which is a linear operation. In the case of a current frame, a pixel-wise subtraction may be performed for the current frame and the prediction frame.

The signal x 710 and the prediction signal \tilde{x} 711 are processed S1430 by applying one or more layers of a neural network 1110, thereby obtaining a set of features g 810. Such a network performs a non-local, non-linear operation on the input data. The obtained set of features g 810 may be regarded as “generalized residual”, inspired by the classical residual signal r 712. The classical residual signal is a difference obtained by performing a subtraction. Accordingly, the operation performed by the neural network 720 may be referred to as “generalized difference” (GD) 720.

Such a neural network 720 may be a convolutional neural network. However, the neural network according to the present embodiments is not limited to a convolutional neural network and may be for instance a multilayer perceptron or RNN (Recurrent Neural Networks) model such as LSTM (Long short-term memory) or Transformer (e.g. Visual Transformer). Any other neural network may be trained to perform (generate) such a generalized difference.

The set of features 810 and the residual signal 712 are encoded S1440 into the bitstream. The encoding may be performed by the encoder 4010 of an autoencoder. Such an autoencoder applies a neural network to obtain a latent representation 4020 of the data to be encoded, which is explained in detail in the section Variational Auto-Encoder with respect to FIG. 4. In general, any current and future autoencoder structure may be used. In the case of an autoencoding neural network the training of the neural network preforming the generalized difference and the autoencoder is performed, for example, in an end-to-end manner. An example for performing the encoding by an encoder 4020 of an autoencoder is shown schematically in FIG. 4. The layers 1110 of the neural network performing the generalized difference are applied to the signal x and the prediction signal \tilde{x} to obtain the generalized residual g. The generalized residual g and the residual signal r=x−\tilde{x} are input to the encoding network 1120 of the autoencoder. The latent representation, which is the output of the exemplary encoding network is entropy encoded into a bitstream 1130. Inputting the residual r into the autoencoding network may lead to a stabilized performance. Such a conditional autoencoder may require less iterations during the training phase.

The encoding may be performed by a hybrid block-based encoder 20. An exemplary implementation for such a hybrid block-based encoder is shown exemplarily in FIG. 5 and is explained in detail in section Hybrid block-based encoder.

In an exemplary implementation, the encoding may include applying one or more of a hyperprior, an autoregressive model, a context model, and a factorized entropy model.

A hyperprior model may be obtained by applying a hyper encoder and a hyper decoder as explained in section Variational image compression. However, the present disclosure is not limited to this example. In an autoregressive model, statistical priors of the data to be encoded are estimated sequentially for each current element to be encoded or decoded. An example for an autoregressive model is a context model. An exemplary context model applies one or more convolutional neural networks to a tensor including samples previously processed in the encoding and/or decoding order. In such a context model, a mask is applied to the input tensor to ensure that samples subsequent in the coding order are not used, for example, by zeroing. A masking may be performed by a masked convolution layer, which zeroes contributions of a current sample and subsequent samples in the coding order.

A factorized entropy model produces an estimation of the statistical properties of data to be encoded. An entropy encoder uses these statistical properties to create a bitstream representation of said data. The factorized entropy model works as a codebook whose parameters are available on the decoder side.

A combination of any of the above-mentioned approaches may be also used. For example, an output of an autoregressive part may be combined with an output of a hyperprior part. This combination may be implemented, for example, by concatenation of the above-mentioned outputs and further processing with one or more layers of a neural network, for example one or more convolutional layers.

As indicated above, a signal may be a multi-dimensional tensor of samples (or values). Such a tensor of samples and thus the respective signal may represent an area. For example, if the signal is tensor of samples of a current frame having dimension C×H×W, the area refers to the dimensions H×W for all channels C. When applied to encoding of images or of a video sequence, the signal to be encoded may be an image (or video frame) or a portion of the image (or video frame) with the horizontal size H (in terms of number of samples) and horizontal size V, and number of channels C. The channels may be color channels, e.g. three color channels R, G, B. However, there may be less than three channels (e.g. in gray-scale images) or more channels, e.g. including further color channels, depth channels or other feature channels.

In a first exemplary embodiment, prior to the encoding of the residual signal 712 into the bitstream 740, a determination may be performed whether or not to set samples of the residual signal 712 within a first area included in said area equal to a default sample value. Such a first area may be the total area represented by the residual signal 712. Such a first area may be a part of the total area represented by the residual signal 712.

For example, such a first area may have a rectangular shape. Such a determination may be performed, for example, on a frame level. The image or video related data to be encoded may correspond to a frame in image or video data. For example, the determination may be performed on a block level. In this exemplary case the frame of image or video data to which the signal to be encoded relates, is separated into blocks. For example, the determination may be performed on predetermined (rectangular or non-rectangular) shapes within the total area. Such predetermined shapes may be obtained by applying a mask indicating at least one area within the total area.

In an exemplary implementation of the first exemplary embodiment, the determination whether or not to set samples of the residual signal 712 within the first area to a default sample value may include determining whether samples are below a predetermined threshold. For example, such a threshold may be defined by a standard. For example, such a threshold may be selected by the encoder and is signaled to the decoder.

For example, the default sample value may be may be defined by a standard. For example, the default sample value may be selected by the encoder and is signaled to the decoder. The default sample value may be equal to zero.

After such a determination whether or not to set samples to a default sample value, a first flag that indicates whether or not the samples of the first area are set equal to the default sample value, is encoded into the bitstream. The first flag may be set to a first value (for example 1) in the case when the samples within the first area are set to the default sample value. The first flag may be set to a second value (for example 0) in the case when the samples within the first area are not set to the default sample value.

Such an exemplary implementation, which sets samples or values within a part of a total area to a default value may be referred to as skip mode.

Similar to the first exemplary embodiment, a skip mode may also be applied to the set of features 810 in a second exemplary embodiment. The set of features 810 may be represented by a multi-dimensional tensor of values. Such a tensor and thus the set of features may represent an area.

In said second exemplary embodiment, prior to the encoding of the set of features 810 into the bitstream 740, a determination may be performed whether or not to set values of the features within a second area included in said area equal to a default feature value. Such determination may be implemented analogously to the determination in the first exemplary embodiment. In an exemplary implementation of the second exemplary embodiment, the determination whether or not to set values of features within the second area to a default feature value may include determining whether values are below a predetermined threshold. For example, such a threshold may be defined by a standard. For example, such a threshold may be selected by the encoder and is signaled to the decoder.

The second area may have rectangular shape. However, the second exemplary embodiment is not limited to rectangular second areas. For example, any shape as explained for the first area in the first exemplary embodiment may also be used for the second area.

For example, the default feature value may be defined by a standard. For example, the default feature value may be selected by the encoder and is signaled to the decoder. The default feature value may be equal to zero.

After such a determination whether or not to set values to a default feature value, a second flag that indicates whether or not the values of the second area are set equal to the default feature value, is encoded into the bitstream 740. The second flag may be set to a third value (for example 1) in the case when the values within the second area are set to the default feature value. The second flag may be set to a fourth value (for example 0) in the case when the values within the second area are not set to the default feature value.

The first exemplary embodiment and the second exemplary embodiment may be combined to apply the skip mode for both, the residual signal and the set of features.

In a third exemplary embodiment, the skip mode is applied for both, the residual signal 712 and the set of features 810. A determination is performed in the third exemplary embodiment whether or not to set samples of the residual signal within a third area included in the total area equal to a default sample value and values of the features within a fourth area included in the total area equal to an default feature value. The determination of the third exemplary embodiment for the residual signal may be performed analogously to the determination for the residual signal in the first exemplary embodiment. The determination for the set of features may be performed analogously to the determination for the set of features as explained in the second exemplary embodiment. At least one of the third and the fourth areas may be of rectangular shape. At least one of the default sample value and the default feature value may be equal to zero.

After such a determination, a third flag that indicates indicating whether or not said samples and said values are set equal to the default sample value and to the default feature value, respectively, is encoded into the bitstream 740. The third flag may be set to a fifth value (for example 1) in the case when the samples of the residual signal within a third area are equal to a default sample value and values of the features within a fourth area are equal to an default feature value. The third flag may be set to a sixth value (for example 0) in the case when the samples of the residual signal within a third area are equal to a default sample value and values of the features within a fourth area are equal to an default feature value.

Any of the skip modes of the first to third exemplary embodiment may reduce the size of the bitstream as areas having a same default value may be compressed more efficiently.

One or more of the flags including the first flag the second flag and the third flag may be binary, e.g. capable of taking either a first value or a second value. However, the present disclosure is not limited to the any of the flags being binary. In general, the application of the skip mode may be indicated in any manner-separately from or joint with other parameters.

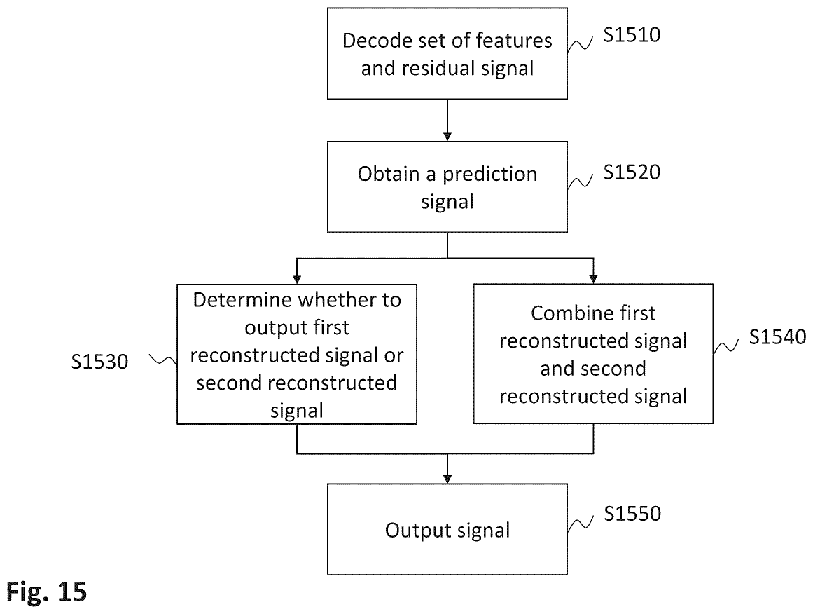

The decoding is exemplarily described by the flowchart in FIG. 15. A signal to be decoded from a bitstream may be a current frame. For example, the signal to be encoded may be a current motion field. However, the present disclosure is not limited to these examples. Any signal related to an image or a video may be decoded.

A set of features ĝ and a residual signal \hat{r} are decoded S1510 from the bitstream. The decoding may be performed by the decoder 4030 of an autoencoder. Such an autoencoder applies a neural network 1140 to obtain data from a latent representation, which is explained in detail in the section Variational Auto-Encoder. The decoding may be performed by a hybrid block-based decoder 30, which is shown exemplarily in FIG. 6.

A prediction signal \tilde{x} may be obtained S1520 analogously to the encoding. Such a prediction signal \tilde{x} is obtained, for example, by using at least one previous signal in the decoding order. In the exemplary case, when the signal to be decoded is a current frame, the prediction signal may be obtained from one or more previous frames. The prediction signal \tilde{x} may be obtained by combining the one or more previous frames with at least one motion field as explained above. In the exemplary case, when the signal to be encoded is a current motion field, the prediction signal \tilde{x} may be obtained from at least one previous motion field.

The outputting S1550 of the signal includes either (i) determining S1530 whether to output a first reconstructed signal 830 or a second reconstructed signal 840, or (ii) combining S1540 the first reconstructed signal 830 and the second reconstructed signal 840.

The first reconstructed signal \hat{x}_{D} 830 is based on the reconstructed residual signal 713 and the prediction signal 711. As the reconstructed residual signal \hat{r} 713 is an actual reconstruction of the residual signal r 712, the first reconstructed signal \hat{x}_{D} 830 is obtained by an inverse of the operation used during encoding. For example, if the residual signal r has been obtained by subtraction r=x−\tilde{x}, the first reconstructed signal 830 is obtained by an addition \hat{x}=\tilde{x}+r. One or more of the samples of the reconstructed residual signal 713 may be equal to zero. For example, when a skip mode is used, a subset of samples within the reconstructed residual signal 713 may be set to zero.

The second reconstructed signal 840 is obtained by processing the reconstructed set of features ĝ 820 and the prediction signal 711 by applying one or more layers of a first neural network 1150. One or more of the values of the reconstructed set of features 820 may be equal to zero. For example, when a skip mode is used, a subset of values within the reconstructed set of features 820 may be set to zero.

For example, the first neural network may be a convolutional neural network, which is explained above. However, the first neural network according to the present embodiments is not limited to a convolutional neural network. Any other neural network may be trained to perform such an operation. Corresponding to the encoding, the operation performed by said first neural network 1150 may be referred to as “generalized sum” (GS). The non-local, non-linear operation of the generalized sum 760 is not necessarily an inverse to the generalized difference.

Both the generalized sum 760 and the generalized difference 720 are non-linear operators different from a “traditional” difference and sum, which are linear. Furthermore, GD and GS take the spatial neighborhood into account, so the analysis of that neighborhood may improve the result. Each of the operators sum, difference, generalized sum and generalized difference has two inputs and one output. For the linear operators sum and difference, both inputs are of the same size and the output is of the same size. This may be relaxed for GD and GS. In particular, GD may produce an output with more channels than either of the inputs and GS may have an input with more channels than the output; also width and heights may differ due to, for example different number of upsamplings/downsamplings within GS and GD.

Thus, the reconstructed generalized residual ĝ 820 contains the same information as the generalized residual g 810. However, the reconstructed generalized residual ĝ 820 may have different channel ordering or the information may be represented in a completely different way. The reconstructed generalized residual ĝ 820 contains the information to reconstruct x under the condition of knowing the prediction frame x.

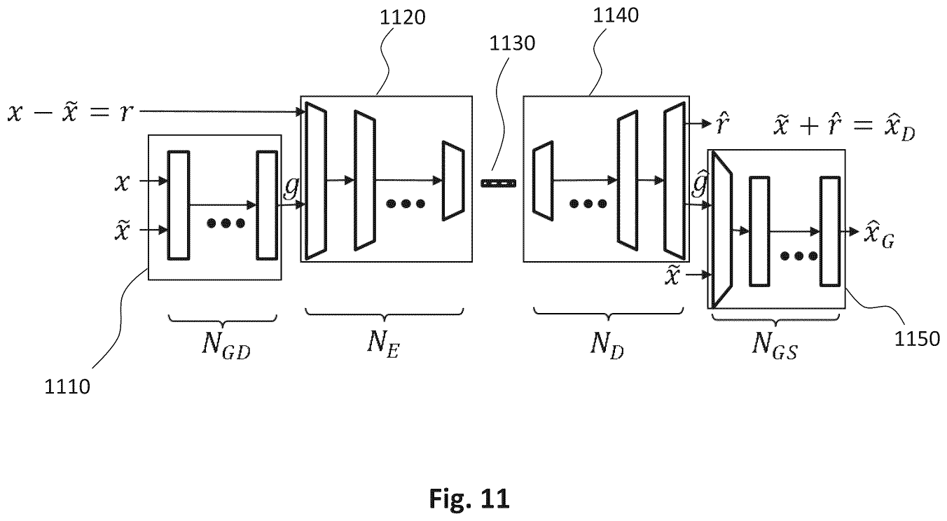

In the case of an autoencoding neural network the training of the neural network performing the generalized sum 760 and the autoencoder is performed, for example, in an end-to-end manner. An example for performing the decoding by a decoder 4030 of an autoencoder is shown schematically in FIG. 11. A latent representation decoded from bitstream 1130 is an input to a decoding network 1140 of the autoencoder. A reconstructed residual signal \hat{r} and a reconstructed generalized residual ĝ are obtained from the exemplary decoding network 1140. The layers of the exemplary network 1150 performing the generalized sum are applied to the generalized residual ĝ to obtain a reconstructed signal \hat{x}_{G}. In one exemplary implementation, the reconstructed residual signal \hat{r} may be an additional input for the exemplary network 1150. So processing of ĝ and \hat{x} may be performed under the condition of knowing the reconstructed residual signal \hat{r}.

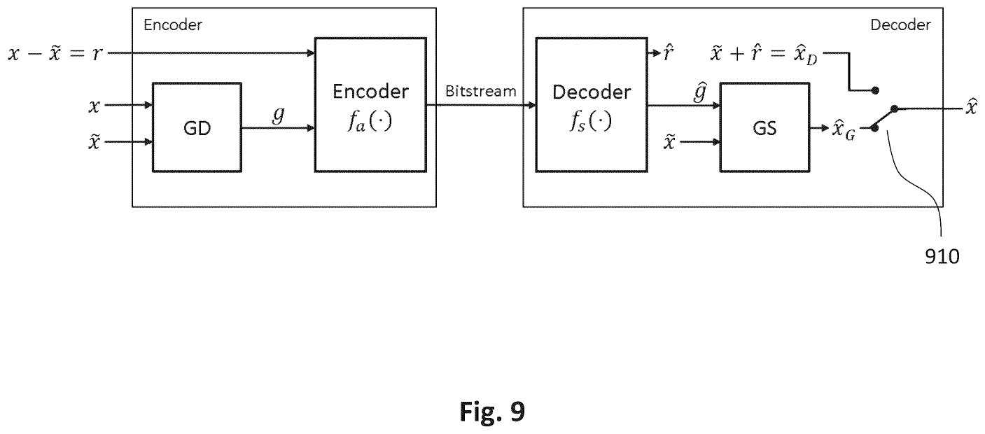

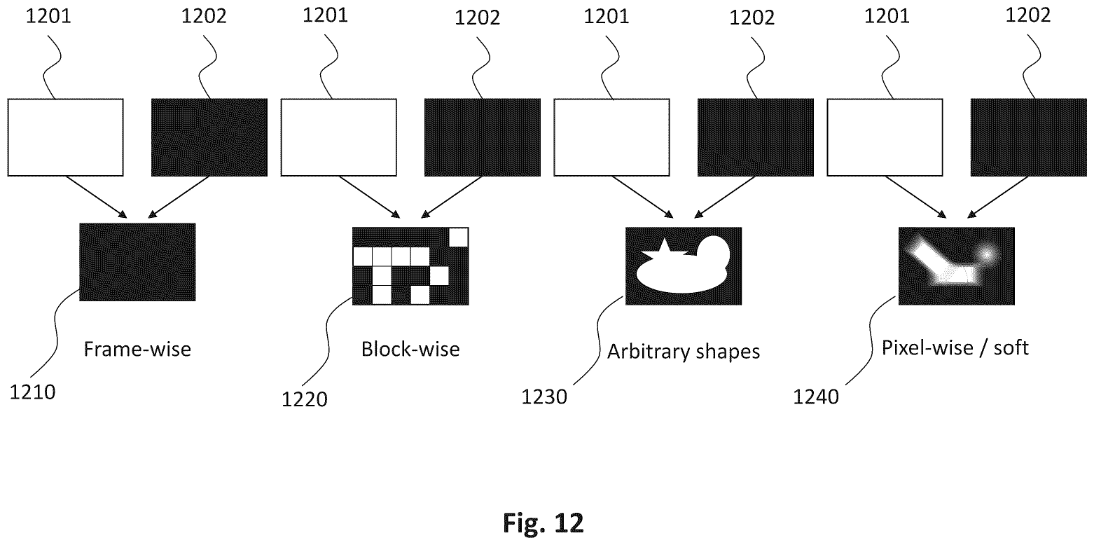

A determination S1530 whether to output a first reconstructed signal 830 or a second reconstructed signal 840, which is exemplarily shown in FIG. 9, may be performed by a switch 910 deciding which of the reconstructed signals is used. Since both reconstructed signals are derived from the same bitstream, and therefore have the same bitrate requirements, the reconstructed signal with the smaller distortion may be chosen. The distortion of the signal may be obtained by using any desired metric, such as Mean Squared Error (MSE), Structural Similarity (SSIM), Video Multimethod Assessment Fusion (VMAF), or the like. In an exemplary implementation, this decision is made on a frame level using MSE. However, the present disclosure is not limited to these examples. Other exemplary implementations may include switching between \hat{x}_{D} and \hat{x}_{G} on a block level or on irregular shapes, which may be produced by an algorithm. Exemplary implementations for performing the determination of the first reconstructed signal 1201 and the second reconstructed signal 1202 are given in FIG. 12.

The determination 1010 may be performed, for example, on a frame level 1210. The image or video related data to be decoded may correspond to a frame in image or video data. For example, the determination 1010 may be performed on a block level 1220. In this exemplary case the frame of image or video data to which the signal to be decoded relates, is separated into blocks 1220. For one exemplary implementation, such a partitioning could be done on a regular basis (regular grid). For another example, one of Quad Tree (QT), Binary Tree (BT) or Ternary tree (TT) partitioning schemas could be used, or combination of them (e.g. QTBT or QTBTTT). For example, the determination 1010 may be performed on predetermined shapes. Such predetermined shapes may be obtained by applying a mask indicating at least one area within a subframe. Such predetermined shapes may be obtained by determining a frame partitioning (set of areas) based on two signals on which a determination and/or combination is to be performed. An exemplary implementation for a determination of a frame partitioning is discussed in PCT/RU2021/000053 (filed on Feb. 8, 2021).

Such predetermined shapes may be obtained by applying a pixel-wise soft mask. Smoothing or softening a mask may improve the results of the picture reconstruction, e.g. by weighting the reconstructed candidate pictures by the weights of the smoothing filter. This feature is useful when residual coding is used, because for the most of known residual coding methods presence of the sharp edges in the residual signal cause significant bitrate increase, which in turn make the whole compression inefficient even if prediction signal quality is improved by the method. For example, the smoothing is performed by Gaussian filtering or guided image filtering. These filters may perform well especially in context if motion picture reconstruction. Gaussian filtering have relatively low complexity, whereas guided image filtering provide smoothing which is better in terms of compression efficiency. An additional benefit of the guided image filtering is that its parameters are more stable in comparison with Gaussian filter's parameters in scenario when a residual coding is performed.

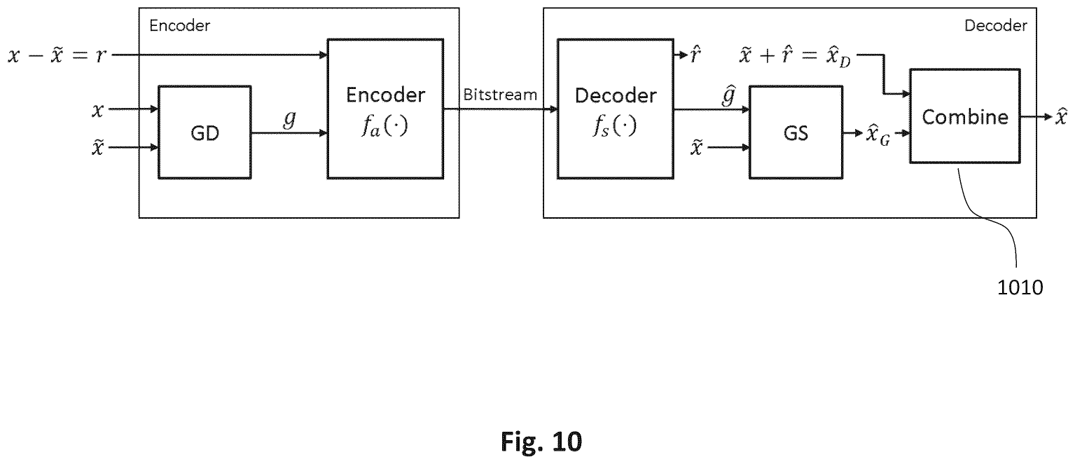

A combination of the first reconstructed signal 830 and the second reconstructed signal 840 may be performed by processing the first reconstructed signal 830 and the second reconstructed signal 840 by applying a second neural network 1010. Such a second neural network may include one or more layers. For example, the second neural network may be a convolutional neural network, which is explained above. However, the second neural network according to the present embodiments is not limited to a convolutional neural network. Any other neural network may be trained to perform such a combination. A schematic flowchart of the encoding and decoding using such a second neural network 1010 is shown in FIG. 10, where the combination performed by the second neural network receives the first reconstructed signal \hat{x}_{D} and the second reconstructed signal \hat{x}_{G} as an input.

Exemplary implementations for the combination of the first reconstructed signal 1201 and the second reconstructed signal 1202 are given in FIG. 12. The second neural network 1010 may be applied, for example, on a frame level 1210. The image or video related data to be decoded may correspond to a frame in image or video data. For example, the second neural network 1010 may be applied on a block level 1220. In this exemplary case the frame of image or video data to which the signal to be decoded relates, is separated into blocks 1220. For example, the second neural network 1010 may be applied on predetermined shapes. Such predetermined shapes may be obtained, similar as above for the determination, by applying a mask indicating at least one area within a subframe. Such predetermined shapes may be obtained, similar as above for the determination, by applying a pixel-wise soft mask. An exemplary implementation includes updating the weights of the second neural network on frame level, on block level, on predetermined shapes or the like, as explained above, thus preserving the structure of the neural network.

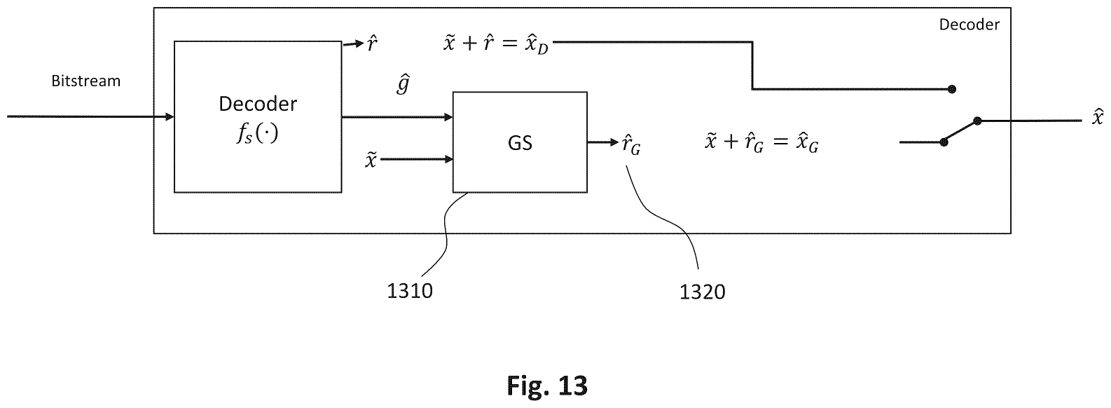

In an exemplary implementation, the prediction signal \tilde{x} may be added to an output 1320 of the first neural network 1310 in the case the second reconstructed signal 840 is obtained. An exemplary scheme is given in FIG. 13. In this example, the network of the generalized sum 1310 receives the prediction frame x and the reconstructed generalized residual ĝ as input. The output represents a second reconstructed residual \hat{r}_{G} that is added to the prediction signal \tilde{x} to obtain the second reconstructed signal \hat{x}_{G} 840.

Analogous to the encoding, the decoding may include applying one or more of a hyperprior, an autoregressive model, and a factorized entropy model. The application of one or more of said models for entropy estimation may be analogous to the encoder side.

According to the encoding, an exemplary implementation of the decoding may include a skip mode. The signal to be decoded represents an area as explained above for the encoding.

In a fourth exemplary embodiment, the decoding of the reconstructed residual signal 713 from the bitstream 740 includes decoding a first flag from the bitstream 740. If the first flag is equal to a predefined value, samples of the reconstructed residual signal 713 within a first area included in said area equal to a default sample value.

The first flag may be equal to a first value (for example 1) in the case when the samples within the first area are set to the default sample value. The first flag may be equal to a second value (for example 0) in the case when the samples within the first area are not set to the default sample value. The shape of the first area may be chosen analogously to the encoding. In a non-limiting exemplary implementation, the first area may have a rectangular form.

For example, the default sample value may be may be defined by a standard. For example, the default sample value may be selected by the encoder and is signaled to the decoder. The default sample value may be equal to zero.

In a fifth exemplary embodiment, the decoding of the reconstructed set of features 820, i.e. the reconstructed generalized residual, from the bitstream includes decoding a second flag from the bitstream. If the second flag is equal to a predefined value, values of the features within a second area included in said total area equal to a default feature value.

The second flag may be equal to a third value (for example 1) in the case when the values within the second area are set to the default feature value. The second flag may be equal to a fourth value (for example 0) in the case when the values within the second area are not set to the default feature value. In a non-limiting exemplary implementation, the first area may have a rectangular form.

For example, the default feature value may be may be defined by a standard. For example, the default feature value may be selected by the encoder and is signaled to the decoder. The default feature value may be equal to zero.

The skip mode for the set of features may include, for instance, a mapping for skip blocks for the generalized residual g to the skip blocks for the reconstructed generalized residual g . For example, skipped areas are the same for all channels, i.e. H_{g}×W_{g} is the same as H_{ĝ}×W_{ĝ}.

The fourth exemplary embodiment and the fifth exemplary embodiment may be combined to apply the skip mode for both, the residual signal and the set of features.

In a sixth exemplary embodiment, the skip mode is applied for both, the reconstructed residual signal 713 and the reconstructed set of features 820. A third flag is decoded from the bitstream in the sixth exemplary embodiment. If the third flag is equal to a predefined value, samples of the reconstructed residual signal 713 within a third area are set to a default sample value and values of the reconstructed features within a fourth area are set to a default feature value.

The third flag may be equal to a fifth value (for example 1) in the case when the samples of the reconstructed residual signal within a third area are equal to a default sample value and values of the reconstructed features within a fourth area are equal to an default feature value. The third flag may be set equal a sixth value (for example 0) in the case when the samples of the reconstructed residual signal within a third area are equal to a default sample value and values of the reconstructed features within a fourth area are equal to an default feature value. The third are and the fourth area and the default values may be implemented corresponding to the encoding. At least one of the third and the fourth areas may be of rectangular shape. At least one of the default sample value and the default feature value may be equal to zero.

Any of the skip modes of the fourth to sixth exemplary embodiment may remove noise caused by non-linear neural network processing from at least one of the reconstructed residual signal and the reconstructed generalized residual by setting the samples or values within the skipped areas to the respective default value.

### Implementations in Hardware and Software

Some further implementations in hardware and software are described in the following.

FIG. 8 exemplarily illustrates the dimension of input, output and intermediate tensors during the encoding and decoding. In this example, the image or video related data x has dimension H×W×C. For example, this refers to the height H, the width W and the number of channels C of a frame within the date. The predicted signal \tilde{x} and the residual signal r are of the same dimension as the signal x. The generalized difference 720 yields the generalized residual g , which has dimension H×W×G . The decoder outputs the reconstructed residual \hat{r} of dimension H×W×C and the reconstructed generalized residual ĝ of dimension H×W×G. As already noted above, G and Ĝ are not necessarily equal. The first reconstructed signal 830 and the second reconstructed signal 840 are again of dimension H×W×C.

FIG. 11 represents an exemplary network structure using the generalized difference and the generalized sum as described above in combination with an autoencoder. In such an exemplary implementation, the encoder 1120 consists of N_{g} convolutional layers with K_{E}ⁱ×Kⁱ_{E} kernels, each having a stride of Sⁱ_{E}, where i represents an index of a layer within the network. In one exemplary implementation K_{E}ⁱ and Sⁱ_{E} do not depend on layer index i. In this case K_{E} and S_{E} may be used without mentioning index i. Furthermore, the encoder may use generalized divisive normalization (GDN) layers as activation functions. It is noted that the present disclosure is not limited to such implementation and in general, other activation functions may be used instead of GDN.

The exemplary decoder in turn consists of N_{D} transposed convolutional layers with K_{D}ⁱ×Kⁱ_{D} kernels, each having a stride of Sⁱ_{D}, where i represents an index of a layer within the network. In one exemplary implementation K_{D}ⁱ and Sⁱ_{D} do not depend on the layer index i. In this case K_{D} and S_{D} may be used without mentioning index i. The decoder may use inverse GDN layers as activation function. In this exemplary implementation, the encoder has C_{img}+C_{g} input channels and C_{img}+C_{ĝ} output channels, where C_{img} is the number of color planes of the image to be encoded and C_{g} and C_{g} are the number of channels of g and ĝ, respectively. Intermediate layers of the encoder and decoder may have C_{E} and C_{D} channels, respectively. Each layer may have a different number of channels.

The generalized difference 1110 may consist of N_{GD} convolutional layers with K_{GD}ⁱ×Kⁱ_{GD} kernels, each having a stride of 1, where i represents an index of a layer within the network. In one exemplary implementation K_{GD}ⁱ and Sⁱ_{GD} do not depend on the layer index i. In this case K_{GD} and S_{CD} may be used without mentioning index i. A stride larger than 1 may be possible, however, in that case at least one of the following two steps has to be performed: First, also include transposed convolutions in the GS to upsample the signal to the same size as the residual. Second, perform downsampling of the residual signal using (trainable and non-linear) operations. In this exemplary implementation, parametric rectified linear units (PRELUs) may be used. It is noted that the present disclosure is not limited to such implementation and in general, other activation functions may be used instead of PRELUs. Each intermediate layer has a C_{GD} channel output and the final layer has a C_{g} channel output. The input are, for example, two color images with C_{img} channels each. In one exemplary implementation, the above-mentioned images may have different number of channels.

The generalized sum 1150 may consist of N_{GS} convolutional layers with K_{GS}ⁱ×Kⁱ_{GS} kernels, each having a stride of 1, where i represents an index of a layer within the network. In one exemplary implementation K_{GS}ⁱ and Sⁱ_{GS} do not depend on the layer index i (layer number). In this case K_{GS} and S_{GS} may be used without mentioning index i. Similar considerations as above for the generalized difference are valid for the stride. In this exemplary implementation, parametric rectified linear units (PReLUs) may be used. The intermediate layers have a C_{GS} channel output, while the final layer has one color image with C_{img} channels as output. For example, the first C_{img} channels of ĝ are identical to \hat{r}, therefore the reconstructed generalized residual ĝ includes C_{ĝ}=C_{g}+C_{img} channels. Therefore, the generalized sum has C_{ĝ}+C_{img} input channels, having the prediction frame as additional input. The parameters in said exemplary implementation may be chosen as follows:

$$\begin{matrix}{N}_{E} = {N}_{D} = 4 \\ {K}_{E} = {K}_{D} = {K}_{G D} = {K}_{G S} = 5 \\ {C}_{E} = {C}_{D} = 64 \\ {C}_{G S} = {C}_{G D} = 16 \\ {C}_{g} = 16 \\ {C}_{\hat{g}} = 19 \\ {N}_{G S} = {N}_{G D} = 3 \\ {S}_{E} = {S}_{D} = 2\end{matrix}$$

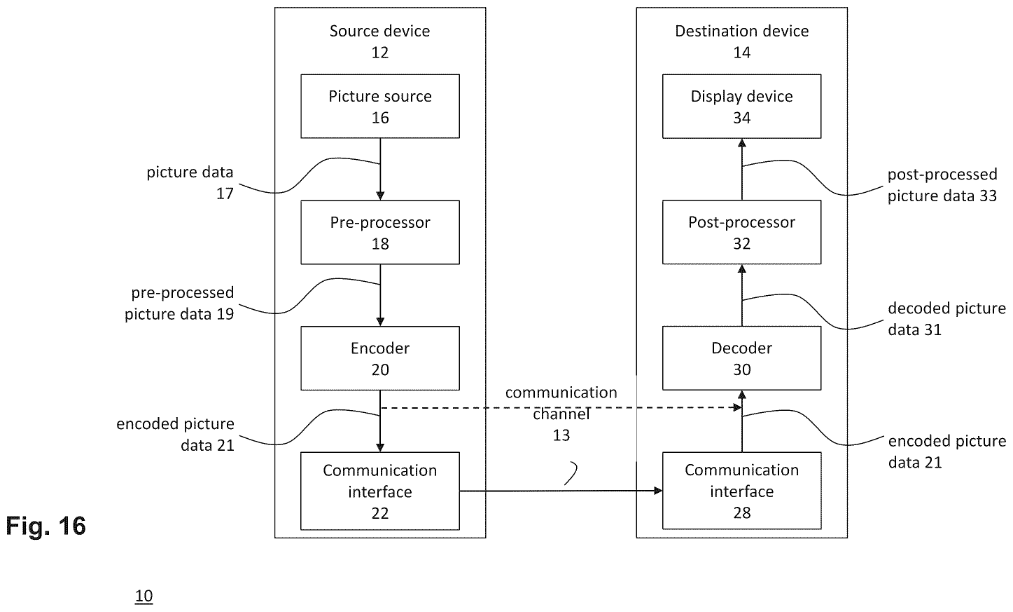

Any of the encoding devices described with references to FIGS. 16 to 19 may provide means in order to carry out the encoding of a signal into a bitstream. A processing circuitry within any of these exemplary devices is configured to obtain a prediction signal, to obtain a residual signal from the signal and the prediction signal, to process the signal and the prediction signal by applying one or more layers of a neural network, thus obtaining a set of features, and to encode the set of features and the residual signal into the bitstream.

The decoding devices in any of FIGS. 16 to 19, may contain a processing circuitry, which is adapted to perform the decoding method. The method as described above comprises decoding from the bitstream a set of features and a residual signal, obtaining a prediction signal, outputting the signal including (i) determining whether to output a first reconstructed signal or a second reconstructed signal, or (ii) combining the first reconstructed signal and the second reconstructed signal, wherein the first reconstructed signal is based on the residual signal and the prediction signal; and the second reconstructed signal is obtained by processing the set of features and the prediction signal by applying one or more layers of a first neural network.

Summarizing, this application provides methods and apparatuses for encoding image or video related data into a bitstream. The present disclosure may be applied in the field of artificial intelligence (AI)-based video or picture compression technologies, and in particular, to the field of neural network-based video compression technologies. A neural network (generalized difference) is applied to a signal and a predicted signal during the encoding to obtain a generalized residual. During the decoding another neural network (generalized sum) may be applied to a reconstructed generalized residual and the predicted signal to obtain a reconstructed signal.

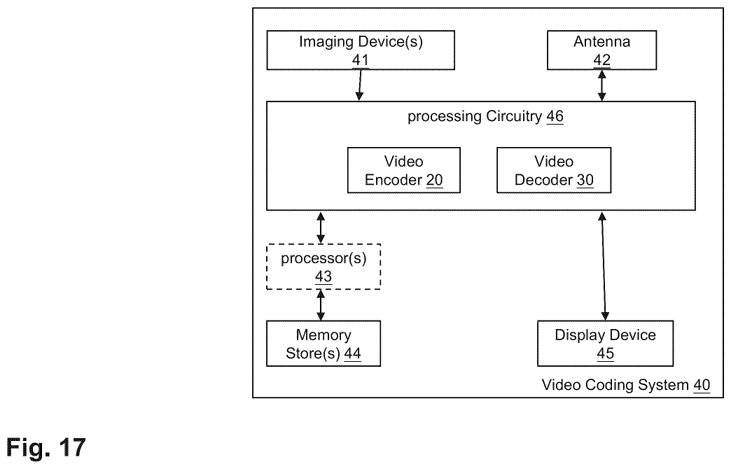

In the following embodiments of a video coding system 10, a video encoder 20 and a video decoder 30 are described based on FIGS. 16 and 17, with reference to the above mentioned FIGS. 5 and 6 or other encoder and decoder such as a neural network based encoder and decoder.

FIG. 16 is a schematic block diagram illustrating an example coding system 10, e.g. a video coding system 10 (or short coding system 10) that may utilize techniques of this present application. Video encoder 20 (or short encoder 20) and video decoder 30 (or short decoder 30) of video coding system 10 represent examples of devices that may be configured to perform techniques in accordance with various examples described in the present application.

As shown in FIG. 16, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component.

The video encoder 20 is configured to receive the pre-processed picture data 19 and provide encoded picture data 21 (further details were described above, e.g., based on FIG. 5).

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.c. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

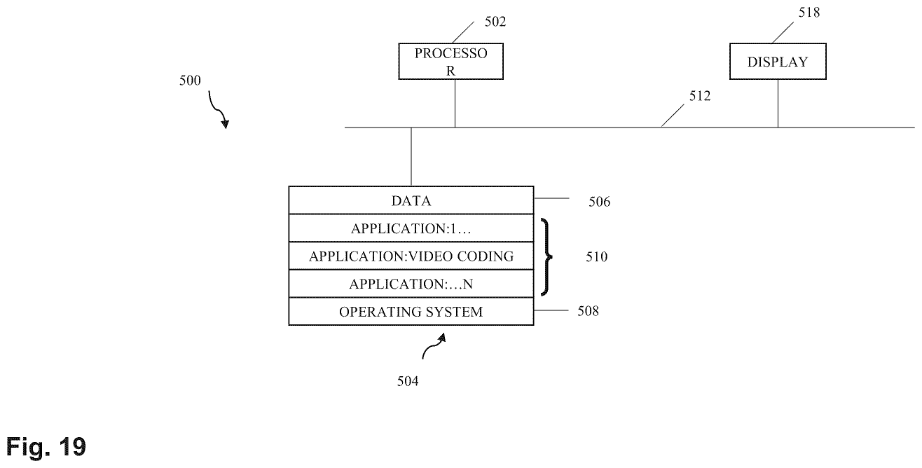

Both, communication interface 22 and communication interface 28 may be configured as unidirectional communication interfaces as indicated by the arrow for the communication channel 13 in FIG. 19 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission.

The decoder 30 is configured to receive the encoded picture data 21 and provide decoded picture data 31 or a decoded picture 31 (further details were described above, e.g., based on FIG. 6).

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 16 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 16 may vary depending on the actual device and application.

The encoder 20 (e.g. a video encoder 20) or the decoder 30 (e.g. a video decoder 30) or both encoder 20 and decoder 30 may be implemented via processing circuitry as shown in FIG. 17, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules as discussed with respect to encoder 20 of FIG. 5 and/or any other encoder system or subsystem described herein. The decoder 30 may be implemented via processing circuitry 46 to embody the various modules as discussed with respect to decoder 30 of FIG. 6 and/or any other decoder system or subsystem described herein. The processing circuitry may be configured to perform the various operations as discussed later. As shown in FIG. 19, if the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 17.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices(such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 16 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

For convenience of description, embodiments of the present disclosure are described herein, for example, by reference to High-Efficiency Video Coding (HEVC) or to the reference software of Versatile Video coding (VVC), the next generation video coding standard developed by the Joint Collaboration Team on Video Coding (JCT-VC) of ITU-T Video Coding Experts Group (VCEG) and ISO/IEC Motion Picture Experts Group (MPEG). One of ordinary skill in the art will understand that embodiments of the present disclosure are not limited to HEVC or VVC.

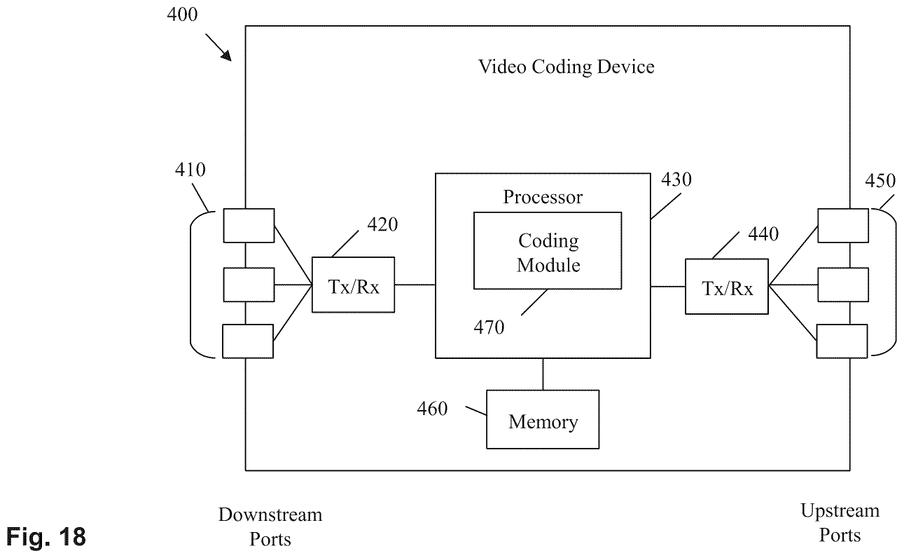

FIG. 18 is a schematic diagram of a video coding device 400 according to an embodiment of the disclosure. The video coding device 400 is suitable for implementing the disclosed embodiments as described herein. In an embodiment, the video coding device 400 may be a decoder such as video decoder 30 of FIG. 16 or an encoder such as video encoder 20 of FIG. 16.

The video coding device 400 comprises ingress ports 410 (or input ports 410) and receiver units (Rx) 420 for receiving data; a processor, logic unit, or central processing unit (CPU) 430 to process the data; transmitter units (Tx) 440 and egress ports 450 (or output ports 450) for transmitting the data; and a memory 460 for storing the data. The video coding device 400 may also comprise optical-to-electrical (OE) components and electrical-to-optical (EO) components coupled to the ingress ports 410, the receiver units 420, the transmitter units 440, and the egress ports 450 for egress or ingress of optical or electrical signals.

The processor 430 is implemented by hardware and software. The processor 430 may be implemented as one or more CPU chips, cores (e.g., as a multi-core processor), FPGAs, ASICs, and DSPs. The processor 430 is in communication with the ingress ports 410, receiver units 420, transmitter units 440, egress ports 450, and memory 460. The processor 430 comprises a coding module 470. The coding module 470 implements the disclosed embodiments described above. For instance, the coding module 470 implements, processes, prepares, or provides the various coding operations. The inclusion of the coding module 470 therefore provides a substantial improvement to the functionality of the video coding device 400 and effects a transformation of the video coding device 400 to a different state. Alternatively, the coding module 470 is implemented as instructions stored in the memory 460 and executed by the processor 430.

The memory 460 may comprise one or more disks, tape drives, and solid-state drives and may be used as an over-flow data storage device, to store programs when such programs are selected for execution, and to store instructions and data that are read during program execution. The memory 460 may be, for example, volatile and/or non-volatile and may be a read-only memory (ROM), random access memory (RAM), ternary content-addressable memory (TCAM), and/or static random-access memory (SRAM).

FIG. 19 is a simplified block diagram of an apparatus 500 that may be used as either or both of the source device 12 and the destination device 14 from FIG. 16 according to an exemplary embodiment.

A processor 502 in the apparatus 500 can be a central processing unit. Alternatively, the processor 502 can be any other type of device, or multiple devices, capable of manipulating or processing information now-existing or hereafter developed. Although the disclosed implementations can be practiced with a single processor as shown, e.g., the processor 502, advantages in speed and efficiency can be achieved using more than one processor.

A memory 504 in the apparatus 500 can be a read only memory (ROM) device or a random access memory (RAM) device in an implementation. Any other suitable type of storage device can be used as the memory 504. The memory 504 can include code and data 506 that is accessed by the processor 502 using a bus 512. The memory 504 can further include an operating system 508 and application programs 510, the application programs 510 including at least one program that permits the processor 502 to perform the methods described here. For example, the application programs 510 can include applications 1 through N, which further include a video coding application that performs the methods described herein, including the encoding and decoding using arithmetic coding as described above.

The apparatus 500 can also include one or more output devices, such as a display 518. The display 518 may be, in one example, a touch sensitive display that combines a display with a touch sensitive element that is operable to sense touch inputs. The display 518 can be coupled to the processor 502 via the bus 512.

Although depicted here as a single bus, the bus 512 of the apparatus 500 can be composed of multiple buses. Further, the secondary storage 514 can be directly coupled to the other components of the apparatus 500 or can be accessed via a network and can comprise a single integrated unit such as a memory card or multiple units such as multiple memory cards. The apparatus 500 can thus be implemented in a wide variety of configurations.

Although embodiments of the present disclosure have been primarily described based on video coding, it should be noted that embodiments of the coding system 10, encoder 20 and decoder 30 (and correspondingly the system 10) and the other embodiments described herein may also be configured for still picture processing or coding, i.e. the processing or coding of an individual picture independent of any preceding or consecutive picture as in video coding. In general only inter-prediction units 244 (encoder) and 344 (decoder) may not be available in case the picture processing coding is limited to a single picture 17. All other functionalities (also referred to as tools or technologies) of the video encoder 20 and video decoder 30 may equally be used for still picture processing, e.g. residual calculation 204/304, transform 206, quantization 208, inverse quantization 210/310, (inverse) transform 212/312, partitioning 262/362, intra-prediction 254/354, and/or loop filtering 220, 320, and entropy coding 270 and entropy decoding 304.

Embodiments, e.g. of the encoder 20 and the decoder 30, and functions described herein, e.g. with reference to the encoder 20 and the decoder 30, may be implemented in hardware, software, firmware, or any combination thereof. If implemented in software, the functions may be stored on a computer-readable medium or transmitted over communication media as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limiting, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

What is claimed is:

1. A method for decoding a signal from a bitstream, the method applied to an electronic decoding apparatus comprising:
decoding (from the bitstream a set of features and a residual signal;
obtaining a prediction signal;
outputting the signal including:
determining (whether to output a first reconstructed signal or a second reconstructed signal, or
combining the first reconstructed signal and the second reconstructed signal; and
wherein the first reconstructed signal is obtained based on the residual signal and the prediction signal; and the second reconstructed signal is obtained by processing the set of features and the prediction signal through applying one or more layers of a first neural network.

2. The method according to claim 1, wherein the combining the first reconstructed signal and the second reconstructed signal comprises:
processing the first reconstructed signal and the second reconstructed signal by applying a second neural network.

3. The method according to claim 2, wherein the second neural network is applied:
on a frame level, or
on a block level, or
on predetermined shapes obtained by applying a mask indicating at least one area within a subframe, or
on predetermined shapes obtained by applying a pixel-wise soft mask.

4. The method according to claim 1, wherein the determination is performed:
on a frame level, or
on a block level, or
on predetermined shapes obtained by applying a mask indicating at least one area within a subframe, or
on predetermined shapes obtained by applying a pixel-wise soft mask.

5. The method according to claim 1, wherein in obtaining the second reconstructed signal, the prediction signal is added to an output of the first neural network.

6. The method according to claim 1, wherein at least one of the first neural network or the second neural network is a convolutional neural network.

7. The method according to claim 1, wherein the decoding the set of features and the residual signal is performed by a decoder of an autoencoder, wherein a training of the first neural network and the autoencoder is performed in an end-to-end manner.

8. The method according to claim 1, wherein the decoding is performed by a hybrid block-based decoder.

9. The method according to claim 1, wherein the decoding the set of features and the residual signal includes applying one or more of
a hyperprior,
an autoregressive model, and
a factorized entropy model.

10. The method according to claim 1, wherein the signal to be decoded is a current frame, wherein the prediction signal is obtained from at least one previous frame and at least one motion field.

11. The method according to claim 1, wherein the signal to be decoded is a current motion field, wherein the prediction signal is obtained from at least one previous motion field.

12. The method according to claim 1, wherein the residual signal represents an area, and
wherein the decoding from the bitstream the residual signal further comprises:
decoding a first flag from the bitstream,
setting samples of the residual signal within a first area included in the area equal to a default sample value based on the first flag being equal to a predefined value.

13. The method according to claim 1, wherein the set of features represents an area,
and wherein the decoding from the bitstream the set of features further comprises:
decoding a second flag from the bitstream,
setting values of the features within a second area included in the area equal to a default feature value based on the second flag being equal to a predefined value.

14. The method according to claim 12, wherein the second area has a rectangular shape.

15. The method according to claim 12, wherein the default feature value is equal to zero.

16. The method according to claim 1, wherein the residual signal represents an area, the set of features represents the area, and
wherein the decoding from the bitstream the set of features and the residual signal further comprises:
decoding a third flag from the bitstream,
setting samples of the residual signal within a third area included in the area equal to a default sample value and values of the features within a fourth area included in the area equal to a default feature value based on the third flag being equal to a predefined value.

17. The method according to claim 16, wherein at least one of the third and the fourth areas has a rectangular shape, wherein at least one of the default sample value and the default feature value is equal to zero.

18. A method for encoding a signal into a bitstream, comprising:
obtaining a prediction signal;
obtaining a residual signal from the signal and the prediction signal;
processing the signal and the prediction signal by applying one or more layers of a neural network, so as to obtain a set of features;
encoding the set of features and the residual signal into the bitstream.

19. The method according to claim 18, wherein the neural network is a convolutional neural network.

20. The method according to claim 18, wherein the encoding the set of features and the residual signal is performed by an encoder of an autoencoder.

21. The method according to claim 20, wherein a training of the neural network and the autoencoder is performed in an end-to-end manner.

22. The method according to claim 18, wherein the encoding the set of features and the residual signal is performed by a hybrid block-based encoder.

23. The method according to claim 18, wherein the encoding the set of features and the residual signal includes applying one or more of
a hyperprior,
an autoregressive model, and
a factorized entropy model.

24. The method according to claim 18, wherein the residual signal represents an area, and
prior to the encoding the residual signal into the bitstream, the following operations are performed:
determining whether or not to set samples of the residual signal within a first area included in the area equal to a default sample value,
encoding a first flag into the bitstream, the first flag indicating whether or not the samples are set equal to the default sample value.
encoding a second flag into the bitstream, the second flag indicating whether or not the samples are equal to the default feature value.

25. A non-transitory computer readable medium having computer programs stored thereon, which, upon being executed on one or more processors, cause the one or more processors to execute the method according to claim 1.

26. An apparatus for decoding a signal into a bitstream, comprising:
a processing circuitry configured to:
decode, from the bitstream, a set of features and a residual signal;
obtain a prediction signal;
output the signal including
determining whether to output a first reconstructed signal or a second reconstructed signal, or
combining the first reconstructed signal and the second reconstructed signal;
wherein the first reconstructed signal is based on the residual signal and the prediction signal, and the second reconstructed signal is obtained by processing the set of features and the prediction signal by applying one or more layers of a neural network.

27. An apparatus for encoding a signal into a bitstream, comprising:
a processing circuitry configured to:
obtain a prediction signal;
obtain a residual signal from the signal and the prediction signal;
process the signal and the prediction signal by applying one or more layers of a neural network, so as to obtain a set of features;
encode the set of features and the residual signal into the bitstream.
